(19) United States
(12) Patent Application Publication
(10) Pub. No.: US 2026/0162205 A1
(43) Pub. Date: Jun. 11, 2026

(54) ELECTRONIC DEVICE FOR PROVIDING IMAGE AND STORAGE MEDIUM THEREOF

(71) Applicant: Samsung Electronics Co., Ltd., Suwon-si (KR)

(72) Inventors: Jungmi KIM, Suwon-si (KR); Haebahremahram SUH, Suwon-si (KR); Jinwan AN, Suwon-si (KR); Eunah LEE, Suwon-si (KR); Jinkyo CHUNG, Suwon-si (KR)

(21) Appl. No.: 19/461,126

(22) Filed: Jan. 27, 2026

Related U.S. Application Data
(63) Continuation of application No. PCT/KR2024/008961, filed on Jun. 27, 2024.

(30) Foreign Application Priority Data
Jul. 28, 2023 (KR) 10-2023-0099184
Oct. 25, 2023 (KR) 10-2023-0143933

(51) Int. Cl. G06T 1/00; G06F 3/04817; G06F 3/0482; G06F 3/04845; G06T 11/60

(52) U.S. Cl. CPC G06T 1/0007; G06F 3/04817; G06F 3/0482; G06F 3/04845; G06T 11/60; G06T 2200/24; G06T 2210/22

(57) ABSTRACT

An electronic device is provided. The electronic device includes memory storing instructions, a display module, and at least one processor operatively connected with the memory and the display module, wherein the instructions, when executed by the at least one processor individually or collectively, cause the electronic device to receive a screen capture command, based on the screen capture command, determine whether an area including at least one moving object exists within a screen being displayed through the display module, based on the area including the at least one moving object existing on the screen, obtain a plurality of image frames captured at a plurality of different time points from the screen, and store at least one image file including at least one image frame selected from among the plurality of image frames.

### CROSS-REFERENCE TO RELATED APPLICATION(S)

This application is a continuation application, claiming priority under 35 U.S.C. § 365(c), of an International application No. PCT/KR 2024/008961, filed on Jun. 27, 2024, which is based on and claims the benefit of a Korean patent application number 10-2023-0099184, filed on Jul. 28, 2023, in the Korean Intellectual Property Office, and of a Korean patent application number 10-2023-0143933, filed on Oct. 25, 2023, in the Korean Intellectual Property Office, the disclosure of each of which is incorporated by reference herein in its entirety.

### BACKGROUND

### 1. Field

The disclosure relates to an electronic device that provides an image and a method of operating same.

### 2. Description of Related Art

With the development of electronic communication technology, various functions are being integrated into communication devices or electronic devices, and an electronic device is being implemented to perform a coupling function in which the electronic device is coupled with another electronic device through communication. For example, an electronic device (e.g., a mobile terminal, a tablet terminal, or a wearable electronic device) may include a communication function as well as an image generation function or an image editing function through a camera, and may capture a screen including information (e.g., an object or content) displayed through the execution of an application as well as a stored image and store the captured screen as an image. The electronic device may store objects displayed on the screen in a specified format, for example, one of text, a table, or a still image.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for capturing and storing a moving image within a screen, and an operation method thereof.

Another aspect of the disclosure is to provide an electronic device for capturing a screen including a video or a moving image as an image, and an operating method thereof.

Another aspect of the disclosure is to provide an electronic device and an operation method thereof that identify an area in which an image moving within a screen is displayed, and capture a plurality of image frames including an image in the area.

Another aspect of the disclosure is to provide an electronic device and an operation method thereof that edit a plurality of image frames obtained by screen capture when a moving image within a screen is detected.

Additional aspects will be set forth in part in the description which follows and, in part, will be apparent from the description, or may be learned by practice of the presented embodiments.

In accordance with an aspect of the disclosure, an electronic device is provided. The electronic device includes memory storing instructions, a display module, and at least one processor operatively connected to the memory and the display module, wherein the instructions, when executed by the at least one processor individually or collectively, cause the electronic device to receive a screen capture command, based on the screen capture command, determine whether an area including at least one moving object exists in a screen being displayed through the display module, obtain a plurality of image frames captured at a plurality of different time points from the screen in case that there is an area including the at least one moving object existing within the screen, store at least one image file including at least one selected image frame among the plurality of image frames.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving a screen capture command, based on the screen capture command, determining whether there is an area including at least one moving object in a screen displayed through a display module, in case that the area including the at least one moving object exists on the screen, obtaining a plurality of image frames captured from the screen at a plurality of different time points, and storing at least one image file including at least one selected image frame among the plurality of image frames.

In accordance with another aspect of the disclosure, a method performed by an electronic device is provided. The method includes receiving a screen capture command, based on the screen capture command, determining whether there is an area including at least one moving object in a screen displayed through a display module, in case that the area including the at least one moving object exists on the screen, obtaining a plurality of image frames captured from the screen at a plurality of different time points, and storing at least one image file including at least one selected image frame among the plurality of image frames.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an electronic device supporting a screen capture according to an embodiment of the disclosure;

FIG. 3 is a flowchart illustrating a procedure for performing a screen capture according to an embodiment of the disclosure;

FIG. 4 is a flowchart illustrating a procedure for selecting an image frame according to an embodiment of the disclosure;

FIGS. 5A and 5B are diagrams illustrating screens displayed in response to a screen capture command according to various embodiments of the disclosure;

FIGS. 6A, 6B, and 6C are diagrams illustrating screens including multiple video areas according to various embodiments of the disclosure;

FIGS. 7A and 7B are diagrams illustrating screens for editing consecutively captured image frames according to various embodiments of the disclosure;

FIGS. 8A and 8B are diagrams illustrating an operation of consecutively capturing a plurality of image frames during video playback according to various embodiments of the disclosure;

FIGS. 9A and 9B are diagrams illustrating an editing interface for a recommended image frame among consecutively captured image frames according to various embodiments of the disclosure;

FIG. 10 is a diagram illustrating a plurality of screens displayed in response to a screen capture command according to an embodiment of the disclosure;

FIG. 11 is a flowchart illustrating a procedure for editing consecutively captured image frames according to an embodiment of the disclosure;

FIGS. 12A and 12B are diagrams illustrating an editing interface for image frames according to various embodiments of the disclosure;

FIGS. 13A, 13B, and 13C are diagrams illustrating an editing interface according to various embodiments of the disclosure;

FIG. 14 is a diagram illustrating a scene transition of a moving image according to an embodiment of the disclosure;

FIG. 15 is a diagram illustrating a scene transition of a video according to an embodiment of the disclosure;

FIGS. 16A and 16B are diagrams illustrating an operation of selecting a desired scene by using a video clip file according to various embodiments of the disclosure;

FIG. 17 is a diagram illustrating an operation of selecting a desired scene through a scene transition according to an embodiment of the disclosure;

FIGS. 18A and 18B are diagrams illustrating an operation of selecting a desired scene among a plurality of scenes listed according to various embodiments of the disclosure;

FIGS. 19A, 19B, and 19C are diagrams illustrating an operation of editing an area corresponding to a moving image according to various embodiments of the disclosure;

FIGS. 20A and 20B are diagrams illustrating an operation of deleting objects of a captured image frame according to various embodiments of the disclosure;

FIGS. 21A, 21B, and 21C are diagrams illustrating an operation of changing objects of a captured image frame according to various embodiments of the disclosure; and

FIGS. 22A, 22B, 22C, and 22D are diagrams illustrating an operation of capturing a periphery of a video region according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

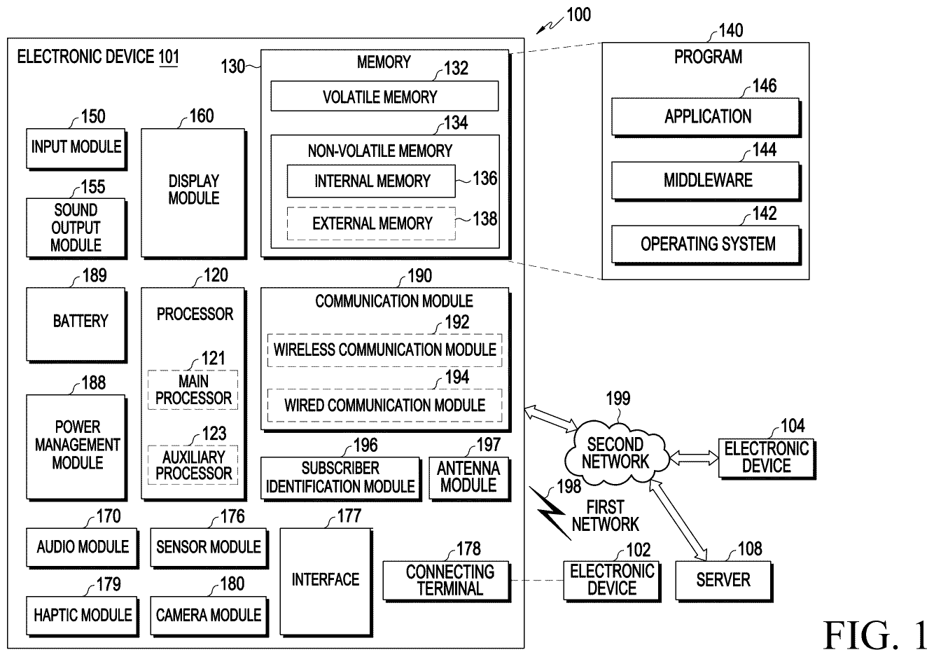

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

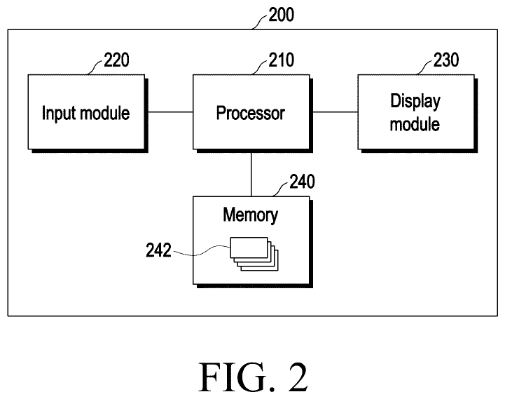

FIG. 2 is a block diagram illustrating an electronic device supporting a screen capture according to an embodiment of the disclosure.

Referring to FIG. 2, an electronic device 200 (e.g., the electronic device 101) may include a processor 210 (e.g., the processor 120), an input module 220 (e.g., the input module 150), a display module 230 (e.g., the display module 160), and/or a memory 240 (e.g., the memory 130).

In an embodiment, the processor 210 may be configured to execute applications (e.g., at least one of a camera application, a video player application, a gallery application, or a web browser application) stored in the memory 240 or an internal memory (not illustrated). The processor 210 may output (e.g., display) information generated by execution of applications to the display module 230. The information may include, for example, at least one of an image obtained by a camera application, a video played by a video player application, an image displayed by a gallery application, and/or text, an image, and/or a video provided by a web browser application.

In an embodiment, the input module 220 may include at least one means (e.g., a volume-down button and a power button, or a microphone) configured to receive a user input for requesting execution of screen capture. The input module 220 may receive a user input (e.g., a screen capture command) requesting a screen capture, and transfer the user input to the processor 210. In an embodiment, the input module 220 may include a touch screen, and may receive a user input for requesting to execute a screen capture (e.g., a user input for a screen capture button provided by a video player application, or a user input for a screen swipe) through the touch screen. The input module 220 may receive, through the touch screen, a user input requesting a screen capture and transfer the user input to the processor 210.

In an embodiment, the display module 230 may output (e.g., display) a screen including information provided by the processor 210, for example, images, videos, and/or texts generated by execution of applications, under the control of the processor 210. The screen may have a size and shape designated by the display module 230. When the processor 210 plays back a video or a moving image (e.g., a video or an animated image), the display module 230 may display the moving image in at least a portion of a screen.

In an embodiment, the memory 240 may store data and information generated by the operation of the processor 210. In an embodiment, the memory 240 may store one or more image frames 242, each of which includes a screen displayed through the display module 230, at a designated time interval (e.g., ¼ second), so that the processor 210 may capture still images of a plurality of time points (e.g., display time points) when a screen capture command is received (e.g., at the current time point). In an embodiment, the processor 210 may store, in the memory 240, a designated number (e.g., N) of image frames 242 during a time period in which the display module 230 is activated, and may capture image frames 242 of a plurality of time points (e.g., a previous time point and a subsequent time of the current time) including the current time point at which a screen capture command is received. In case that a screen capture command is not received, the image frames 242 stored in the memory 240 may be deleted after a designated time.

In an embodiment, the memory 240 may store image frames 242 captured by the processor 210 according to a screen capture command, and may store information for editing the captured image frames 242 (e.g., an edited image frame or at least one object of the image frame). In an embodiment, the memory 240 may store the captured image frames 242 while the processor 210 is editing the captured image frames 242.

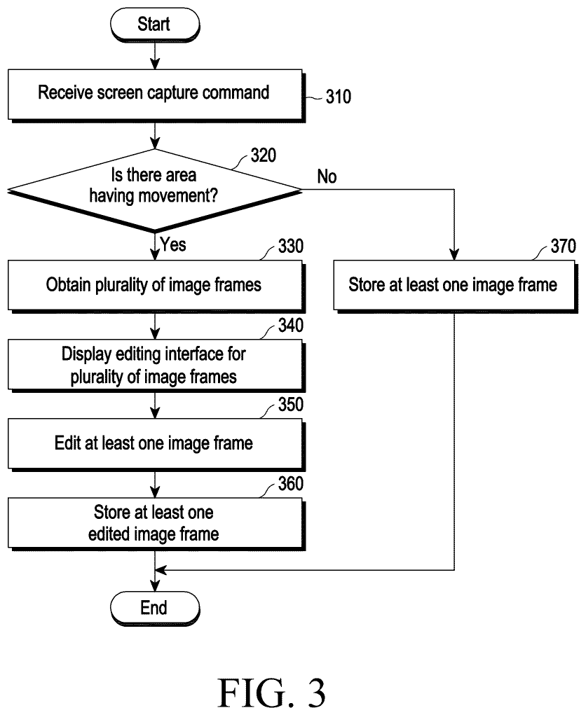

FIG. 3 is a flowchart illustrating a procedure for performing a screen capture according to an embodiment of the disclosure. In an embodiment, at least one of operations described below may be executed by the processor 210 of the electronic device 200. According to embodiments, at least one of operations described below may be omitted, or modified, or executed in a different order.

Referring to FIG. 3, in operation 310, the electronic device 200 (e.g., the processor 210) may receive a screen capture command. In an embodiment, the screen capture command may be input from a user through the input module 220 or the display module 230, or may be generated by the electronic device 200 (e.g., the processor 210) according to a designated algorithm. In an embodiment, the screen capture command may mean an input for capturing a screen being displayed. For example, the screen capture command may include at least one of pressing a particular physical button (e.g., a combination of a volume-down button and a power button) of the input module 220, detecting a screen swipe through the display module 230, or a user input (e.g., a touch) for a screen capture button provided by a screen capture application (e.g., a video player application).

Although not illustrated, in an embodiment, the electronic device 200 (e.g., the processor 210) may receive an input for enabling a consecutive screen capture through a user configuration, and may proceed to operation 320 based on identifying that the consecutive screen capture is enabled when the screen capture command is received. When the screen capture command is received, and if a consecutive screen capture is not enabled, the electronic device 200 (e.g., the processor 210) may proceed to operation 370 without performing operation 320.

In operation 320, the electronic device 200 (e.g., the processor 210) may determine whether there is an area including a movement within a screen being output through the display module 230, based on reception of the screen capture command. In an embodiment, the area including the movement may be an area including at least one moving object. In an embodiment, the area having the movement may be an area including a moving image (e.g., a video or an animated image). In an embodiment, the electronic device 200 (e.g., the processor 210) may determine whether the screen includes an area in which a content (e.g., at least one object) is moving at a current time point at which the screen capture command is received.

In an embodiment, in case that a video player application or a gallery application is being executed in at least a portion of the screen displayed by the display module 230, the electronic device 200 (e.g., the processor 210) may determine that there is an area including at least one moving object within the screen. In an embodiment, in case that source code of a web page displayed by a web browser application includes a file extension of a video file, the electronic device 200 (e.g., the processor 210) may determine that there is an area including at least one moving object within the screen. In an embodiment, the electronic device 200 (e.g., the processor 210) may identify the existence, size, and/or shape of an area including at least one moving object within the screen.

In case that there is an area including the at least one moving object, the electronic device 200 (e.g., the processor 210) may proceed to operation 330. In case that there is no area including the at least one moving object, the electronic device 200 (e.g., the processor 210) may proceed to operation 370.

In operation 330, the electronic device 200 (e.g., the processor 210) may obtain (e.g., capture) a plurality of (e.g., N) image frames corresponding to a screen being displayed through the display module 230. In an embodiment, the electronic device 200 (e.g., the processor 210) may obtain (e.g., read out), from the memory 240, a plurality of image frames corresponding to a plurality of time points including a current time at which the screen capture command is received. In an embodiment, the electronic device 200 (e.g., the processor 210) may download a video clip file being played in the area from a server, based on source code of a web page being displayed by a web browser application. The video clip file may include the plurality of image frames. In an embodiment, the plurality of image frames may include one or more previous image frames and/or one or more subsequent image frames, based on a time point when the screen capture command is received.

In an embodiment, the electronic device 200 (e.g., the processor 210) may receive a user input for determining the number of image frames to be captured. For example, the electronic device 200 (e.g., the processor 210) may consecutively capture image frames including a screen displayed through the display module 230 from a time point when a user input (e.g., a press or a long touch) through a designated interface (e.g., a physical button, or a screen capture button) is started to a time point when the user input is ended.

In operation 340, the electronic device 200 (e.g., the processor 210) may display an editing interface of the plurality of image frames. In an embodiment, the editing interface may include an interface for selecting at least one image frame among the plurality of image frames. In an embodiment, the editing interface (e.g., editing interfaces 524, 624, 714, 724, 814, and 916) may include a first editing interface including at least one of a video crop interface (e.g., a video crop interface 918), a scroll capture interface (e.g., a scroll capture interface 716), an area selection interface, a tag insertion interface, or a sharing interface. In an embodiment, the electronic device 200 (e.g., the processor 210) may store at least one selected image frame (e.g., at least one best image frame) among the plurality image frames. In an embodiment, the electronic device 200 (e.g., the processor 210) may omit operations 340 and 350, and proceed to operation 360 to store the selected at least one image frame.

In an embodiment, the editing interface may include a second editing interface including at least one of a playback interface (e.g., a playback interface 1240) for playing back the plurality of image frames as a video, a scene movement interface (e.g., scene movement interfaces 1238a and 1238b) for moving to an image frame of a desired scene among the plurality of image frames, an area editing interface (e.g., an area editing interface 1232, an area hiding interface 1912, or an area cropping interface 1914) for editing an area having a movement (e.g., an area including at least one moving object) among at least one image frame, or an object editing interface (e.g., an object editing interface 1234, an object deleting interface 2012, or an object changing interface 2112) for editing at least one object included in at least one image frame.

In an embodiment, the second editing interface is for use in editing a designated area (e.g., an area including a still image captured from a moving image), and may be displayed through the display module 230 in response to receiving a user input through the area selection interface of the first editing interface.

In operation 350, the electronic device 200 (e.g., the processor 210) may edit at least one of the plurality of image frames, based on a user input through the editing interface. In an embodiment, the electronic device 200 (e.g., the processor 210) may select at least one image frame from the plurality of image frames, and output the selected image frame through the display module 230. In an embodiment, the electronic device 200 (e.g., the processor 210) may change (e.g., delete or crop) at least a portion of the area of at least one image frame being output through the display module 230.

In an embodiment, the electronic device 200 (e.g., the processor 210) may change (e.g., hide or crop) at least a portion of the area of at least one image frame being output through the display module 230. In an embodiment, the electronic device 200 (e.g., the processor 210) may change (e.g., change or replace) at least some objects of at least one image frame being output through the display module 230.

In operation 360, the electronic device 200 (e.g., the processor 210) may store at least one image frame edited through the editing interface. In an embodiment, the at least one image frame may be stored as at least one image file (e.g., a screenshot file).

In an embodiment, the electronic device 200 (e.g., the processor 210) may, after obtaining the plurality of image frames in operation 330, omit operations 340 and 350 and proceed to operation 360. In operation 360, the electronic device 200 (e.g., the processor 210) may store at least one image file including at least one selected image frame among the plurality of image frames. In an embodiment, the electronic device 200 (e.g., the processor 210) may select the at least one image frame among the multiple image frames, based on a user input or an image difference.

In operation 370, the electronic device 200 (e.g., the processor 210) may capture one image frame including the screen at the current time point. The captured image frame may be stored as a single image file (e.g., a screenshot file).

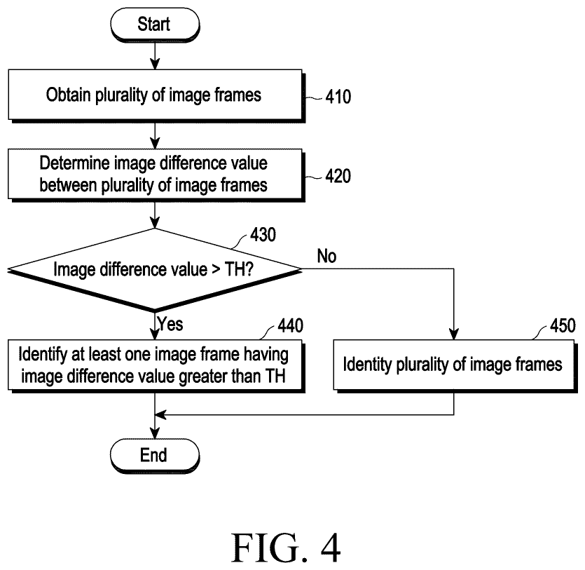

FIG. 4 is a flowchart illustrating a procedure for selecting an image frame according to an embodiment of the disclosure. In an embodiment, at least one of operations described below may be executed by the processor 210 of the electronic device 200. According to embodiments, at least one of operations described below may be omitted, or modified, or executed in a different order. In an embodiment, at least one of the operations described below may correspond to operation 330 of FIG. 3.

Referring to FIG. 4, in operation 410, the electronic device 200 (e.g., the processor 210) may obtain a plurality of image frames corresponding to a plurality of time points. In an embodiment, the electronic device 200 (e.g., the processor 210) may capture a screen displayed through the display module 230 at a plurality of time points, based on the screen capture command being received. In an embodiment, the electronic device 200 (e.g., the processor 210) may read out one or more image frames (e.g., image frames 242) stored in the memory 240.

In operation 420, the electronic device 200 (e.g., the processor 210) may determine (e.g., calculate) image difference values corresponding to the plurality of image frames. Each of the image difference values may indicate the degree to which an image frame is clearly distinguishable from other image frames. In an embodiment, the electronic device 200 (e.g., the processor 210) may calculate an image difference value of the first image frame by quantifying an image difference between the first image frame and at least one second image frame different from the first frame (e.g., at least one previous image frame and/or at least one subsequent image frame) among the plurality of image frames.

In operation 430, the electronic device 200 (e.g., the processor 210) may compare the image difference values of the plurality of image frames with a designated threshold (e.g., TH). In case that all of the image difference values are not greater than TH, the electronic device 200 (e.g., the processor 210) may proceed to operation 440. In case that all of the image difference values are greater than TH, the electronic device 200 (e.g., the processor 210) may proceed to operation 450.

In operation 440, the electronic device 200 (e.g., the processor 210) may identify at least one image frame having an image difference value greater than TH, among the plurality of image frames, as an object to be edited or an object to be captured. In an embodiment, the electronic device 200 (e.g., the processor 210) may identify the first image frame as an object to be edited or an object to be captured if an image difference between the first image frame and the previous and/or subsequent image frames is greater than TH.

In operation 450, the electronic device 200 (e.g., the processor 210) may identify all of the plurality of image frames as an object to be edited or an object to be captured.

The electronic device 200 (e.g., the processor 210) may perform at least one of operation 340, 350, or 360 with respect to the at least one image frames identified as an object to be edited or an object to be captured.

According to an embodiment, the electronic device 200 (e.g., the processor 210) may calculate a size of a degraded area in the first image frame instead of calculating the image difference value in operation 420. Here, the degradation area may be defined as an area among the first image frames similar to the previous image frame and/or the subsequent image frame. In an embodiment, the electronic device 200 (e.g., the processor 210) may compare the first image frame with the previous image frame and/or the subsequent image frame on a pixel-by-pixel or pixel group-by-pixel group basis, for example, to calculate pixel-by-pixel or pixel group-by-pixel image difference values, and calculate a size (e.g., a ratio to the entire area of the first image frame) of an area (e.g., a degraded area) including pixels or pixel groups having image having difference values smaller than a designated threshold (e.g., TH).

In case that the size (e.g., the ratio) of the degraded area of the first image frame is smaller than a designated threshold, the electronic device 200 (e.g., the processor 210) may determine the first image frame as an object to be edited or an object to be captured. In case that the size (e.g., the ratio) of the degraded area of the first image frame is not smaller than a designated threshold, the electronic device 200 may determine that the first image frame is not an object to be edited or an object to be captured. An image frame not selected as an object to be edited or an object to be captured may be discarded (e.g., deleted).

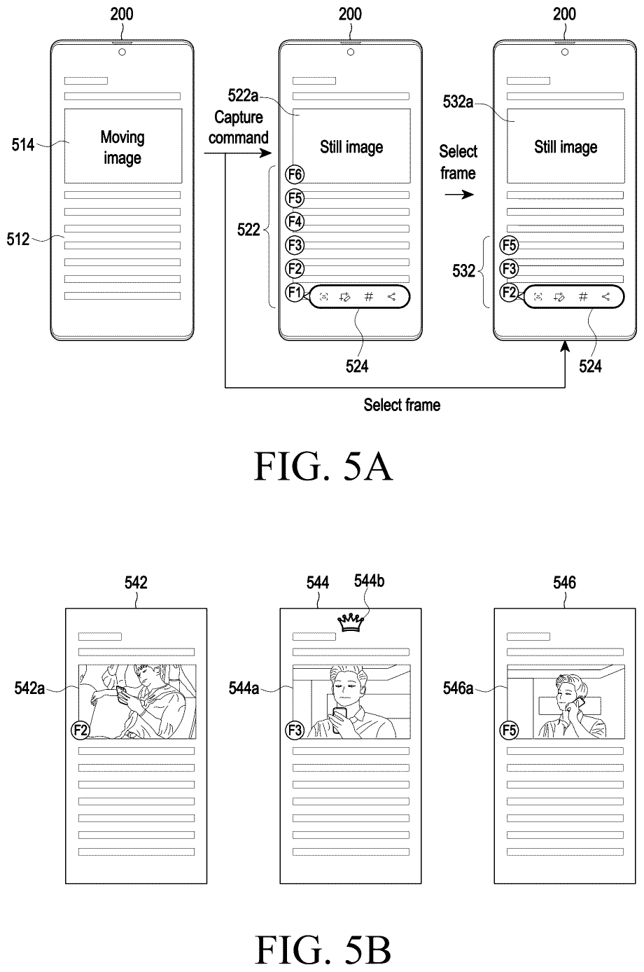

FIGS. 5A and 5B are diagrams illustrating screens displayed in response to a screen capture command according to various embodiments of the disclosure.

Referring to FIG. 5A, the electronic device 200 (e.g., the processor 210) may display a first screen 512 including a moving image 514 through the display module 230. In an embodiment, the moving image 514 may refer to an area in which a video or a moving image is played, or an area in which a video or an animated image is played on a web page.

In response to receiving the screen capture command, the electronic device 200 (e.g., the processor 210) may display thumbnail images 522 of a plurality of image frames (e.g., F1, F2, F3, F4, F5, and F6) through the display module 230. Each of the plurality of image frames (e.g., F1, F2, F3, F4, F5, and F6) may include a still image 522a captured at a different time point (e.g., a consecutive capturing time points) from the moving image 514. In an embodiment, the thumbnail images 522 may be displayed in an overlapping manner on the first screen 512. In an embodiment, the thumbnail images 522 may be arranged so that the user may distinguish and identify the thumbnail images 522, or may be displayed such that the thumbnail images 522 are at least partially overlapped with each other.

In an embodiment, the electronic device 200 (e.g., the processor 210) may display an editing interface 524 related to image editing, together with the thumbnail images 522. In an embodiment, the editing interface 524 may include at least one of a scroll capture interface, an area selection interface, a tag insertion interface, or a sharing interface.

In an embodiment, in response to a user input (e.g., a touch) for selecting at least one of the thumbnail images 522, the electronic device 200 (e.g., the processor 210) may display thumbnail image 532 of at least one image frame (e.g., F2, F3, and F5) selected from among the plurality of image frames (e.g., F1, F2, F3, F4, F5, and F6). In an embodiment, the thumbnail images 532 may be displayed in an overlapping manner on the first screen 512.

In an embodiment, in response to receiving a screen capture command during display of the first screen 512, the electronic device 200 (e.g., the processor 210) may display thumbnail images 532 of at least one image frame (e.g., F2, F3, and F5) selected from among the plurality of image frames (e.g., F1, F2, F3, F4, F5, and F6) through the display module 230. Each of at least one image frame (e.g., F2, F3, and F5) may include a still image 532a captured from the area 514 in which a moving image exists.

In an embodiment, the electronic device 200 (e.g., the processor 210) may select at least one image frame (e.g., F2, F3, and F5) from among a plurality of image frames (e.g., F1, F2, F3, F4, F5, and F6) captured at the time point when the screen capture command is received, the at least one image frame having a clear image difference (e.g., having an image difference value greater than TH) from the previous and/or the previous image frames, and may display only a thumbnail image (e.g., the thumbnail images 532) of the selected at least one image frame (e.g., F2, F3, and F5).

Referring to FIG. 5B, the electronic device 200 (e.g., the processor 210) may store at least one image frame (e.g., the image frame 542 corresponding to F2, the image frame 544 corresponding to F3, and the image frame 546 corresponding to F5) corresponding to at least one thumbnail image selected from among the thumbnail images 522 or the thumbnail images 532 as at least one image file (e.g., a screenshot file). The image frame 542 may include a still image 542a captured from an area 514 at a time point of F2. The image frame 544 may include a still image 544a captured from the area 514 at a time point of F3. The image frame 546 may include a still image 546a captured from the area 514 at a time point of F5.

In an embodiment, the electronic device 200 (e.g., the processor 210) may store at least one selected image frame (e.g., F2, F3, and F5) based on a user selection. In an embodiment, the electronic device 200 (e.g., the processor 210) may select and store at least one image frame (e.g., F2, F3, and F5) having an image difference value greater than a designated threshold (e.g., TH). In an embodiment, the electronic device 200 (e.g., the processor 210) may store recommendation information 544b with regard to the selected at least one image frame (e.g., the image frame 544 of F3). In an embodiment, when the electronic device 200 (e.g., the processor 210) displays the selected image frames (e.g., F2, F3, and F5), the electronic device 200 may display recommendation information 544b (e.g., a sticker image) together with at least one image frame having the largest image difference value (e.g., the image frame 544 of F3).

In an embodiment, after a designated time period has elapsed since the thumbnail images 522 or the thumbnail images 532 are displayed, the electronic device 200 (e.g., the processor 210) may store the image frames corresponding to all of the displayed thumbnail images as image files (e.g., screenshot files), respectively.

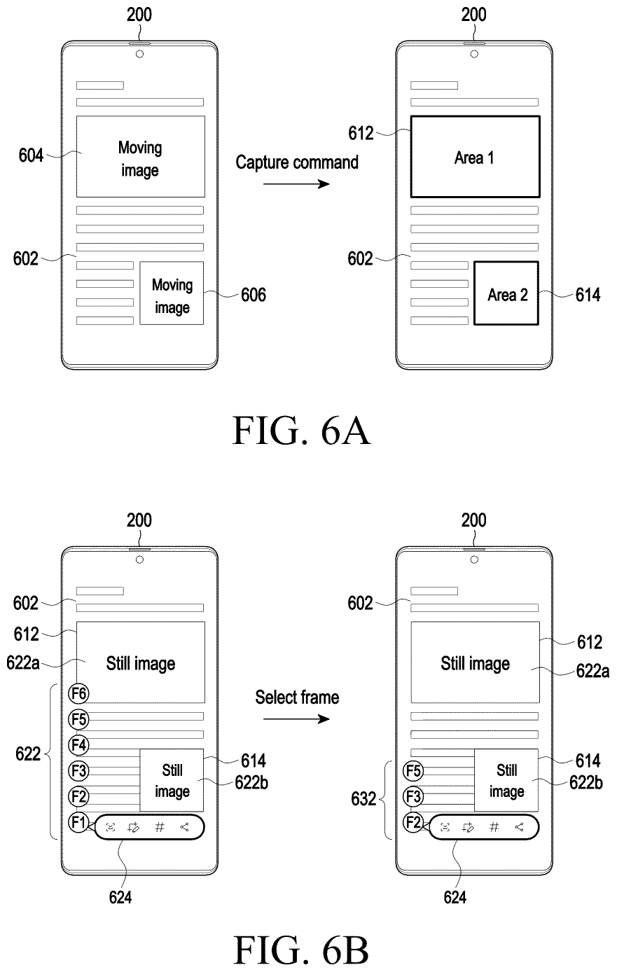

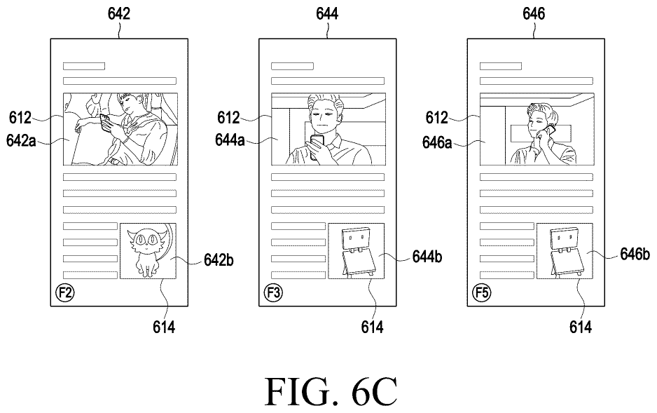

FIGS. 6A, 6B, and 6C are diagrams illustrating screens including multiple video areas according to various embodiments of the disclosure.

Referring to FIG. 6A, the electronic device 200 (e.g., the processor 210) may display a moving image 604 and a first screen 602 including the moving image 606 through the display module 230. In an embodiment, the moving image 604 and/or the moving image 606 may refer to an area in which a video or a moving image is played, or an area in which a video or an animated image is played on a web page.

Referring to FIG. 6B, in response to receiving a screen capture command, the electronic device 200 (e.g., the processor 210) may identify area 1 612 including the moving image 604 (e.g., a video or an animated image) in the first screen 602 and/or area 2 614 including the moving image 606 (e.g., a video or an animated image). In response to receiving the screen capture command, the electronic device 200 (e.g., the processor 210) may display thumbnail images 622 of a plurality of image frames (e.g., F1, F2, F3, F4, F5, and F6) which respectively include still images 622a and 622b captured from the moving image 604 and/or the moving image 606.

In an embodiment, the still image 622a may be displayed within area 1 612, and the still image 622b may be displayed within area 2 614. In an embodiment, the thumbnail images 622 may be displayed in an overlapping manner on the first screen 602. In an embodiment, the thumbnail images 622 may be arranged so that the user may distinguish and identify the thumbnail images 622, or may be displayed such that the thumbnail images 522 are at least partially overlapped with each other.

In an embodiment, in response to receiving a screen capture command, the electronic device 200 (e.g., the processor 210) may display an editing interface 624 related to image editing, together with the thumbnail images 622. In an embodiment, the editing interface 624 may include at least one of a scroll capture interface, an area selection interface, a tag insertion interface, or a sharing interface.

In an embodiment, the electronic device 200 (e.g., the processor 210) may display thumbnail images 632 of at least one image frame (e.g., F2, F3, and F5) selected from among the thumbnail images 622, based on a user input or an image difference value. In an embodiment, the thumbnail images 632 may be displayed in an overlapping manner on the first screen 602. In an embodiment, the electronic device 200 (e.g., the processor 210) may calculate both a first image difference value of area 1 612 and a second image difference value of area 2 614 for each image frame. In an embodiment, the electronic device 200 (e.g., the processor 210) may capture the image frame of F2 and display a thumbnail image thereof, even if the image difference value of area 1 612 is less than TH or is relatively small for the image frame of F2, as long as the image difference of area 2 614 is greater than TH or is relatively large.

Referring to FIG. 6C, the electronic device 200 (e.g., the processor 210) may store at least one image frame (e.g., the image frame 642 corresponding to F2, the image frame 644 corresponding to F3, and the image frame 646 corresponding to F5) corresponding to at least one thumbnail image selected from among the thumbnail images 622 or the thumbnail images 632 as at least one image file. The image frame 642 may include a still image 642a captured from the moving image 604 and a still image 642b captured from the moving image 606 in area 1 612 and area 2 614, respectively. The image frame 644 may include a still image 644a captured from the moving image 604 and a still image 644b captured from the moving image 606 in area 1 612 and area 2 614. The image frame 646 may include a still image 646a captured from the moving image 604 and a still image 646b captured from the moving image 606 in area 1 612 and area 2 614.

In an embodiment, at least one of the image frame 642, the image frame 644, or the image frame 646 may include and store the moving image 604 and still images respectively captured from the moving image 604 at different time points in the corresponding areas 612 and 614. For example, the electronic device 200 (e.g., the processor 210) may generate and display and/or store an image frame (not illustrated) including a still image 642a corresponding to F2 and a still image 644b corresponding to F3, based on the image frame 642 and the image frame 644.

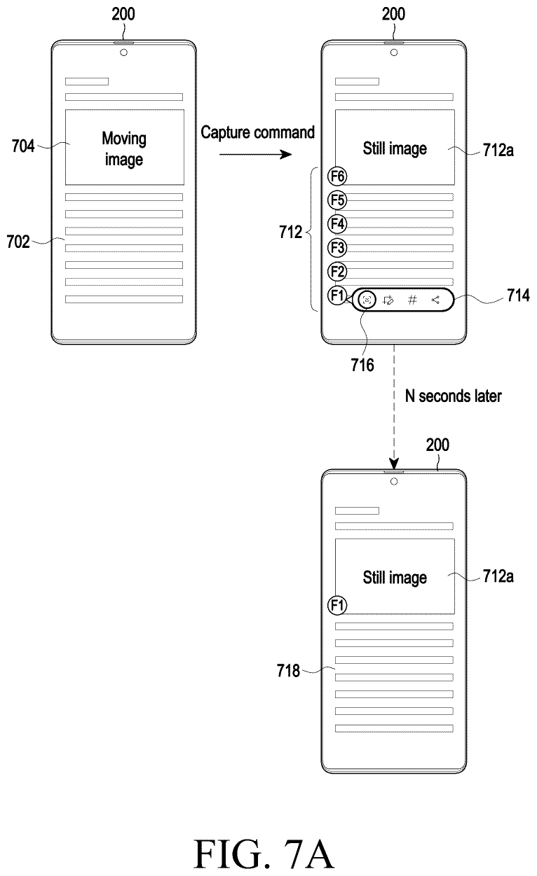

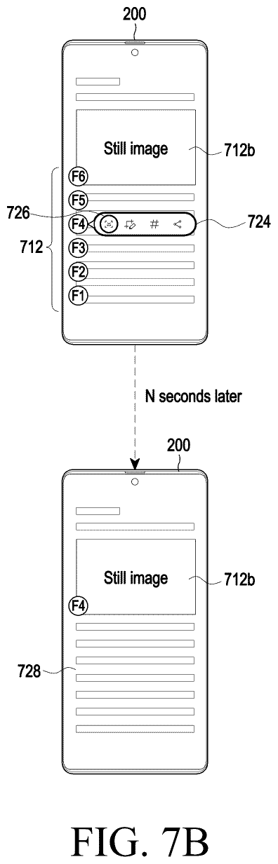

FIGS. 7A and 7B are diagrams illustrating screens for editing consecutively captured image frames according to various embodiments of the disclosure.

Referring to FIG. 7A, the electronic device 200 (e.g., the processor 210) may display a first screen 702 including a moving image 704 through the display module 230. In an embodiment, the moving image 704 may be displayed in an area in which an application for playing back a video or a moving image is executed, or in an area in which a video or an animated image is played on a web page.

In response to receiving the screen capture command, the electronic device 200 (e.g., the processor 210) may display thumbnail images 712 of a plurality of image frames (e.g., F1, F2, F3, F4, F5, and F6) through the display module 230. Each of the plurality of image frames (e.g., F1, F2, F3, F4, F5, and F6) may include a still image (e.g., a still image 712a of F1) captured at a different time point (e.g., a consecutive capturing time points) from the moving image 514. In an embodiment, the thumbnail images 712 may be displayed in an overlapping manner on the first screen 702. In an embodiment, the thumbnail images 712 may be arranged so that the user may distinguish and identify the thumbnail images 712, or may be displayed such that the thumbnail images 522 are at least partially overlapped with each other.

In an embodiment, in response to receiving a screen capture command, the electronic device 200 (e.g., the processor 210) may display an editing interface 714 related to image editing, together with the thumbnail images 712. In an embodiment, the editing interface 714 may include at least one of a scroll capture interface 716, an area selection interface, a tag insertion interface, or a sharing interface. In an embodiment, the editing interface 714 may be disposed to be associated with (e.g., in an adjacent position to) any one (e.g., a thumbnail image of the foremost image frame or a thumbnail image of an image frame having the best image quality) selected from among the thumbnail images 712, and may be used to edit the selected image frame.

In an embodiment, when a user input (e.g., a touch) is received through the scroll capture interface 716 in the editing interface 714 displayed to be associated with the image frame of F1, the electronic device 200 (e.g., the processor 210) may perform scroll capture for remaining contents of the web page not displayed on the first screen 702, following the image frame of F1. In response to the user input through the scroll capture interface 716, the electronic device 200 (e.g., the processor 210) may replace the image frame of F1 with a scroll-captured image frame.

In an embodiment, in a state in which the editing interface 714 is displayed to be associated with the image frame of F1, the electronic device 200 (e.g., the processor 210) may, based on receiving a user input (e.g., a touch) for selecting a thumbnail image corresponding to the image frame of F1, display an image frame 718 including the still image 712a of F1 including the still image 712a through the entire display module 230 (e.g., in place of the first screen 702).

In an embodiment, when a user input is not received for a designated time period (e.g., N seconds) in a state in which the editing interface 714 is displayed, the electronic device 200 (e.g., the processor 210) may store the selected image frame (e.g., the image frame of F1) 718 as an image file. In another embodiment, if no user input is received for a designated time period (e.g., N seconds) in a state in which the editing interface 714 is displayed, the electronic device 200 (e.g., the processor 210) may store all captured image frames (e.g., image frames of F1 to F6) as image files, respectively.

Referring to FIG. 7B, the electronic device 200 (e.g., the processor 210) may, based on receiving a user input (e.g., a touch) for selecting one (e.g., a thumbnail image 722 corresponding to an image frame of F4) of the thumbnail images 712 of a plurality of image frames (e.g., F1, F2, F3, F4, F5, and F6) captured according to a screen capture command, display an image frame including a selected still image 712b of F4, and/or display an editing interface 724 to be associated with (e.g., in a nearby location of) the thumbnail image 722. The editing interface 724 may include at least one of a scroll capture interface 726, an area selection interface, a tag insertion interface, or a sharing interface, similarly to the editing interface 714.

In an embodiment, when a user input (e.g., a touch) is received through the scroll capture interface 726 in the editing interface 724 displayed to be associated with the image frame of F4, the electronic device 200 (e.g., the processor 210) may perform scroll capture for remaining contents of the web page not displayed on the first screen 702, following the image frame of F4. In response to the user input through the scroll capture interface 726, the electronic device 200 (e.g., the processor 210) may replace the image frame of F4 with a scroll-captured image frame.

In an embodiment, in a state in which the editing interface 724 is displayed to be associated with the image frame of F4, the electronic device 200 (e.g., the processor 210) may, based on receiving a user input (e.g., a touch) for selecting a thumbnail image corresponding to the image frame of F4, display an image frame 728 including the still image 712a of F1 through the entire display module 230 (e.g., in place of the first screen 702).

In an embodiment, when a user input is not received for a designated time period (e.g., N seconds) in a state in which the editing interface 724 is displayed, the electronic device 200 (e.g., the processor 210) may store the selected image frame (e.g., the image frame of F4) 728 as an image file. In another embodiment, if no user input is received for a designated time period (e.g., N seconds) in a state in which the editing interface 724 is displayed, the electronic device 200 (e.g., the processor 210) may store all captured image frames (e.g., image frames of F1 to F6) as image files, respectively.

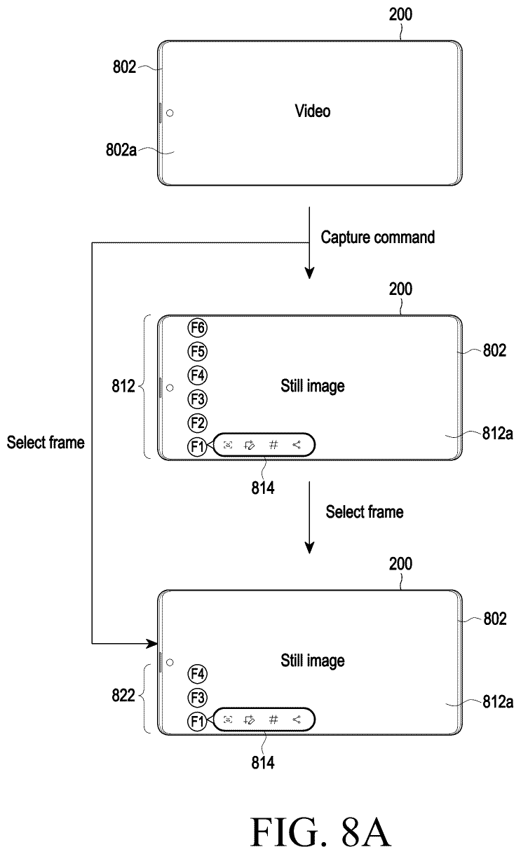

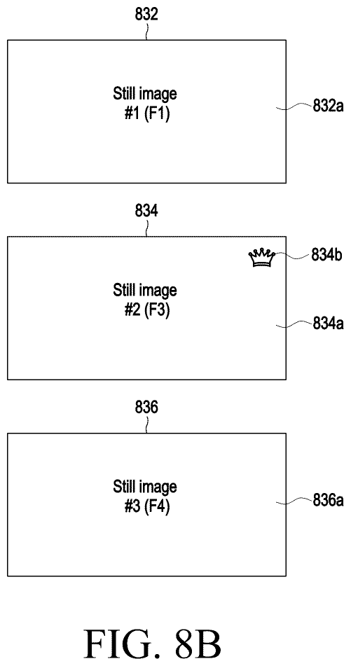

FIGS. 8A and 8B are diagrams illustrating an operation of consecutively capturing a plurality of image frames during video playback according to various embodiments of the disclosure.

Referring to FIG. 8A, the electronic device 200 (e.g., the processor 210) may display a first screen 802 including a video 802a being played through the display module 230. In an embodiment, the first screen 802 may include an area in which the video 802a is played by a video application or an area in which the video application is executed.

In response to receiving the screen capture command, the electronic device 200 (e.g., the processor 210) may display thumbnail images 812 of a plurality of image frames (e.g., F1, F2, F3, F4, F5, and F6) through the display module 230. Each of the plurality of image frames (e.g., F1, F2, F3, F4, F5, and F6) may include a still image 812a captured at a different time point (e.g., a consecutive capturing time points) from the video 802a being played. In an embodiment, the thumbnail images 812 may be displayed in an overlapping manner on the first screen 802. In an embodiment, the thumbnail images 812 may be arranged so that the user may distinguish and identify the thumbnail images 812, or may be displayed such that the thumbnail images 522 are at least partially overlapped with each other.

In an embodiment, the electronic device 200 (e.g., the processor 210) may display an editing interface 814 related to image editing, together with the thumbnail images 812. In an embodiment, the editing interface 814 may include at least one of a scroll capture interface, an area selection interface, a tag insertion interface, or a sharing interface. In an embodiment, the editing interface 814 may be disposed to be visually associated with (e.g., in an adjacent position to) any one (e.g., a thumbnail image of the foremost image frame or a thumbnail image of an image frame having the best image quality) selected from among the thumbnail images 812, and may be used to edit the selected image frame.

In an embodiment, in response to a user input (e.g., a touch) for selecting at least one of the thumbnail images 812, the electronic device 200 (e.g., the processor 210) may display thumbnail image 822 of at least one image frame (e.g., F1, F3, and F4) selected from among the plurality of image frames (e.g., F1, F2, F3, F4, F5, and F6). In an embodiment, the thumbnail images 822 may be displayed in an overlapping manner on the first screen 802. The electronic device 200 (e.g., the processor 210) may display an editing interface 814 related to image editing, together with the thumbnail images 822.

In an embodiment, in response to receiving a screen capture command during display of the first screen 802, the electronic device 200 (e.g., the processor 210) may display thumbnail images 822 of at least one image frame (e.g., F1, F3, and F4) selected from among the plurality of image frames (e.g., F1, F2, F3, F4, F5, and F6) through the display module 230.

In an embodiment, the electronic device 200 (e.g., the processor 210) may select at least one image frame (e.g., F1, F3, and F4) from among a plurality of image frames (e.g., F1, F3, F3, F4, F5, and F6) captured at the time point when the screen capture command is received, the at least one image frame having a clear image difference (e.g., having an image difference value greater than TH) from the previous and/or the previous image frames, and may display only a thumbnail image (e.g., the thumbnail images 822) of the selected at least one image frame (e.g., F1, F3, and F4).

Referring to FIG. 8B, the electronic device 200 (e.g., the processor 210) may store at least one image frame (e.g., the image frame 832 corresponding to F1, the image frame 834 corresponding to F3, and the image frame 836 corresponding to F4) corresponding to at least one thumbnail image selected from among the thumbnail images 812 or the thumbnail images 822 as at least one image file. The image frame 832 may include still image #1 832a captured from the video 802a at the time point of F1. The image frame 834 may include still image #2 834a captured from the video 802a at the time point of F3. The image frame 836 may include still image #3 836a captured from the video 802a at the time point of F4.

In an embodiment, the electronic device 200 (e.g., the processor 210) may select and store the image frames (e.g., F1, F3, and F4) based on a user selection or an image difference. In an embodiment, the electronic device 200 (e.g., the processor 210) may store recommendation information 834b with regard to the selected at least one image frame (e.g., the image frame 834 of F3) having a largest image difference value. In an embodiment, when the electronic device 200 (e.g., the processor 210) displays the selected image frames (e.g., F1, F3, and F4), the electronic device 200 may display recommendation information 834b (e.g., a designated image symbol) together with at least one image frame having the largest image difference value (e.g., the image frame 834 of F3).

In an embodiment, after a designated time period has elapsed since the thumbnail images 812 or the thumbnail images 822 are displayed, the electronic device 200 (e.g., the processor 210) may store the image frames corresponding to all of the displayed thumbnail images as image files, respectively.

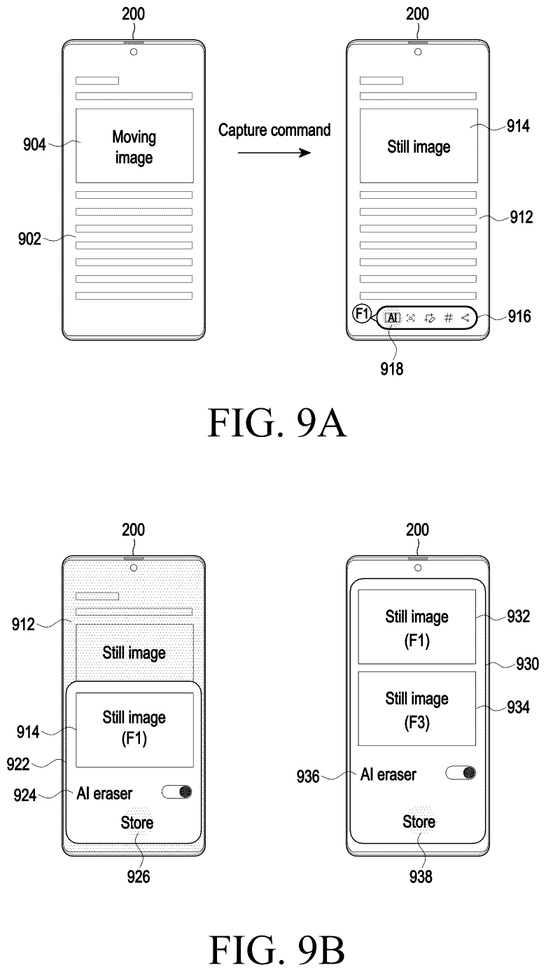

FIGS. 9A and 9B are diagrams illustrating an editing interface for a recommended image frame among consecutively captured image frames according to various embodiments of the disclosure.

Referring to FIG. 9A, the electronic device 200 (e.g., the processor 210) may display a first screen 902 including a moving image 904 through the display module 230. In an embodiment, the first screen 902 may include an area in which the moving image 904 (e.g., a video or an animated image) in a web page is played.

In response to receiving the screen capture command, the electronic device 200 (e.g., the processor 210) may obtain a plurality of image frames (e.g., F1, F2, F3, F4, F5, and F6) (not illustrated), and may display at least one (e.g., an image frame 912 of F1) selected from among the plurality of image frames through the display module 230. Each of the plurality of image frames (e.g., F1, F2, F3, F4, F5, and F6) may include a still image (e.g., a still image 914) captured at a different time point (e.g., a consecutive capturing time points) from the moving image 904. The electronic device 200 (e.g., the processor 210) may select at least one image frame (e.g., the image frame 912) to be captured, based on a user input or an image difference.

In an embodiment, the electronic device 200 (e.g., the processor 210) may determine (e.g., calculate) image difference values with other image frames for each of the plurality of image frames (e.g., F1, F2, F3, F4, F5, and F6), identify at least one image frame (e.g., the image frame 912) having the largest image difference value, and display the identified image frame 912 through the display module 230.

In an embodiment, the electronic device 200 (e.g., the processor 210) may display an editing interface 916 related to image editing, together with the image frame 912. In an embodiment, the editing interface 916 may include at least one of a video cropping interface 918, a scroll capture interface, an area selection interface, a tag insertion interface, or a sharing interface. In an embodiment, when a user input (e.g., a touch) is received through the video crop interface 918 in the editing interface 916, the electronic device 200 (e.g., the processor 210) may identify a still image 914 captured from a moving image 904 in the image frames 912, by, for example, a pre-stored artificial intelligence (AI) algorithm.

Referring to FIG. 9B, the electronic device 200 (e.g., the processor 210) may display an area 922 including the still image 914 to be visually distinguishable from the image frame 912. The area 922 may include, in addition to the still image 914, a first input interface 924 (e.g., an AI eraser) for editing (e.g., deleting) additional information (e.g., at least one of a video title, a subtitle, or a video control object) related to the still image 914, and/or a second input interface 926 for storing the still image 914. In an embodiment, the area 922 may be displayed so as to at least partially overlap the image frame 912.

In case that a user input (e.g., a touch) is received through the second input interface 926 while the first input interface 924 is selected (e.g., enabled or turned on) by the user, the electronic device 200 (e.g., the processor 210) may store an image file including the still image 914 in which related additional information is deleted from the image frame 912. In case that a user input (e.g., a touch) is received through the second input interface 926 while the first input interface 924 is in a disabled state (e.g., turned off), the electronic device 200 (e.g., the processor 210) may store an image file including the still image 914 (e.g., including related additional information) cropped from the image frame 912.

In an embodiment, the electronic device 200 (e.g., the processor 210) may display an area 930 including one or more images 932 and 934 captured from a screen (e.g., the first screen 602) including one or more moving images (e.g., the moving image 604 and the moving image 606), based on receiving a screen capture command. The one or more images 932 and 934 may each include partial areas of different image frames (e.g., F1 and F3) captured at different time points. In an embodiment, the area 930 may include, in addition to the one or more images 932 and 934, a first input interface 936 (e.g., an AI eraser) for editing (e.g., deleting) additional information (e.g., at least one of a video title, a subtitle, or a video control object) related to the one or more images 932 and 934, and/or a second input interface 938 for storing the images 932 and 934.

In case that a user input (e.g., a touch) is received through the second input interface 938 while the first input interface 936 is selected (e.g., enabled or turned on) by the user, the electronic device 200 (e.g., the processor 210) may store one image file including the images 932 and 934 in which the related additional information has been deleted. In case that a user input (e.g., a touch) is received through the second input interface 938 while the first input interface 936 is in a disabled state (e.g., turned off), the electronic device 200 (e.g., the processor 210) may store an image file including the images 932 and 934 including the related additional information.

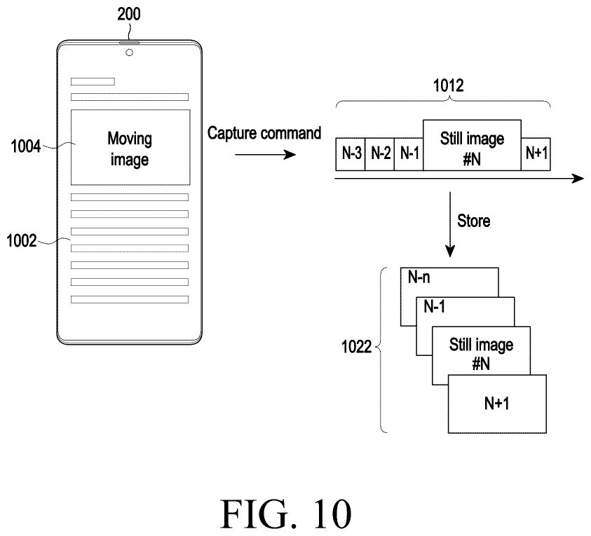

FIG. 10 is a diagram illustrating a plurality of screens displayed in response to a screen capture command according to an embodiment of the disclosure.

Referring to FIG. 10, the electronic device 200 (e.g., the processor 210) may display a first screen 1002 including a moving image 1004 through the display module 230. In an embodiment, the first screen 1002 may include an area in which the moving image 1004 (e.g., a video or an animated image) in a web page is played.

In response to receiving the screen capture command, the electronic device 200 (e.g., the processor 210) may capture a plurality of still images 1012. In an embodiment, the plurality of still images 1012 may include information of a screen displayed on the display module 230 at a plurality of time points (e.g., consecutive capturing time points) including a current time point N when the screen capture command is received. For example, the plurality of still images 1012 may include not only still image #N captured from the first screen 1002 at a current time point N, but also one or more still images (e.g., still images #N-3, #N-2, and #N-1) before the current time point and/or one or more still images (e.g., still image #N+1) after the current time point.

In an embodiment, the electronic device 200 (e.g., the processor 210) may select at least some still images 1022 (e.g., still images #N−2, #N−1, #N, and #N+1) from among the plurality of still images 1012, based on a user input. In an embodiment, the electronic device 200 (e.g., the processor 210) may select at least some still images 1022 (e.g., still images #N−2, #N−1, #N, and #N+1) from among the plurality of still images 1012, based on image difference values of the still images 1012. The electronic device 200 (e.g., the processor 210) may store an image frame including the selected still images 1022 as image files.

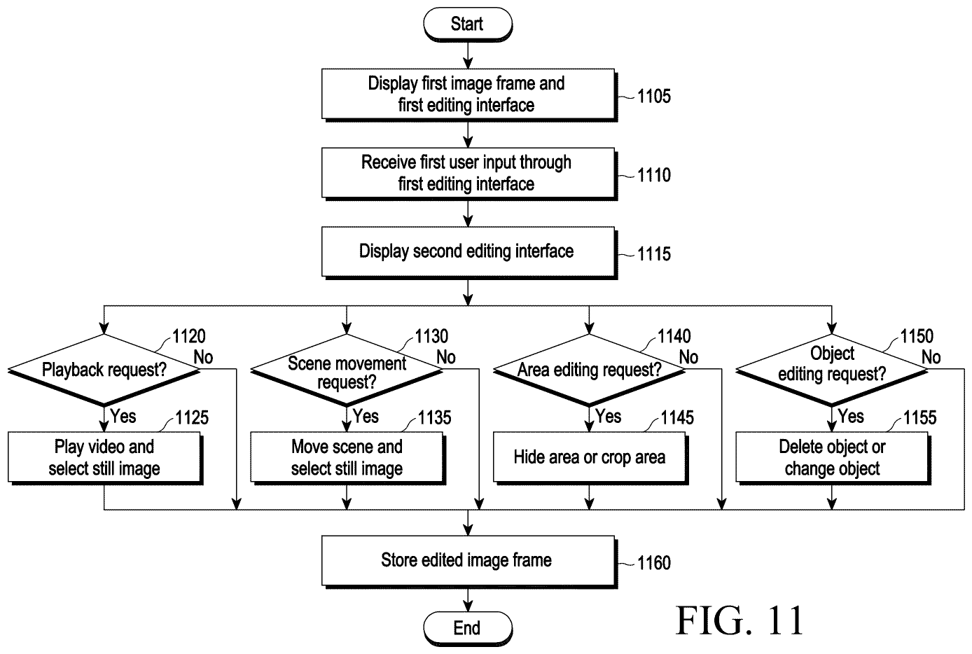

FIG. 11 is a flowchart illustrating a procedure for editing consecutively captured image frames according to an embodiment of the disclosure. In an embodiment, at least one of operations described below may be executed by the processor 210 of the electronic device 200. According to embodiments, at least one of operations described below may be omitted, or modified, or executed in a different order. In an embodiment, at least one of the operations described below may correspond to operation 350 of FIG. 3.

Referring to FIG. 11, in operation 1105, the electronic device 200 (e.g., the processor 210) may display, through the display module 230, a selected first image frame among a plurality of image frames captured according to a screen capture command, and an editing interface (e.g., a first editing interface). In an embodiment, the first image frame may be selected from the plurality of image frames, based on a user input or an image difference. In an embodiment, the first image frame may include at least one still image (e.g., the still image 622a and the still image 622b) captured from at least one area (e.g., area 1 612 and/or area 2 614) having a movement.

In an embodiment, the first editing interface may include at least one of a video crop interface (e.g., the video crop interface 918), a scroll capture interface (e.g., the scroll capture interface 716), an area selection interface, a tag insertion interface, or a sharing interface.

In operation 1110, the electronic device 200 (e.g., the processor 210) may receive a first user input for invoking a second editing interface through the first editing interface. In an embodiment, the first user input may include a touch on the video cropping interface.

In operation 1115, the electronic device 200 (e.g., the processor 210) may display the second editing interface through the display module 230. In an embodiment, the second editing interface may be displayed together with the first image frame to be visually distinguishable from the first image frame or partially overlapped with the first image frame, for example.

In an embodiment, the second editing interface may include at least one of a playback interface (e.g., a playback interface 1240), a scene movement interface (e.g., a scene movement interface 1238a or 1238b), an area editing interface 1232, an object editing interface 1234, or an area selection interface 1236. In an embodiment, the second editing interface may be used to edit at least one still image (e.g., the still image 622a and the still image 622b) captured from at least one area (e.g., area 1 612 and/or area 2 614) having a movement. In an embodiment, the electronic device 200 (e.g., the processor 210) may display an area (e.g., an area including at least one still image captured from at least one area (e.g., area 1 612 and/or area 2 614) having a movement) related to the second editing interface in the first image frame, so that the area is visually distinguishable from other areas of the first image frame.

In an embodiment, at least one of the playback interface, the scene movement interface, the area editing interface, or the object editing interface may be displayed to be visually associated with at least one still image captured from at least one area having a movement in the first image frame. At least one of the playback interface, the scene movement interface, the area editing interface, or the object editing interface may be displayed so as to at least partially overlap the at least one still image.

In operation 1120, the electronic device 200 (e.g., the processor 210) may determine whether a second user input (e.g., a touch) requesting video playback through a playback interface (e.g., the playback interface 1240) in the second editing interface is received. In case that the second user input for requesting video playback is received, the electronic device 200 (e.g., the processor 210) may proceed to operation 1125. In case that the second user input for requesting video playback is not received, the electronic device 200 (e.g., the processor 210) may proceed to operation 1160.

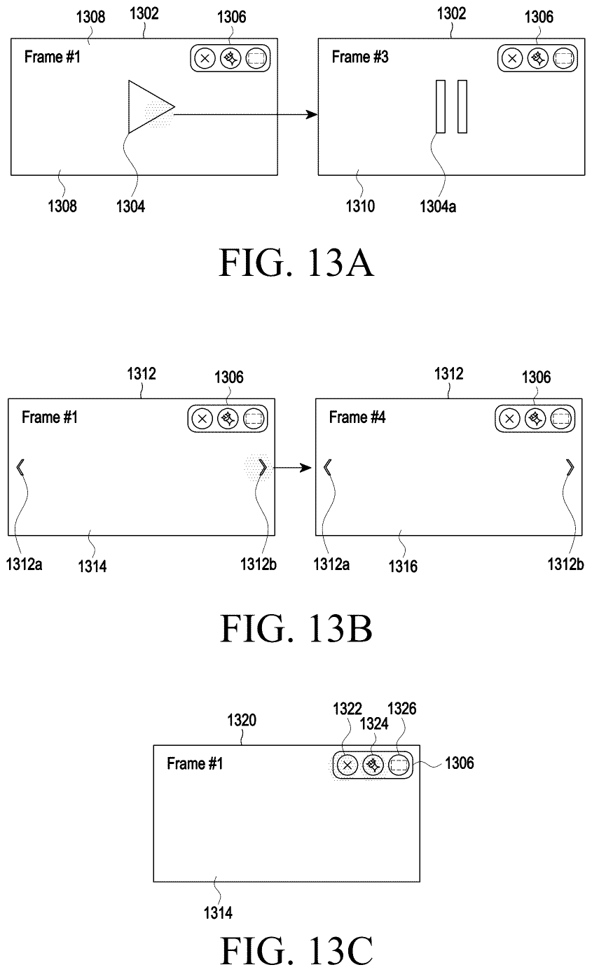

In operation 1125, the electronic device 200 (e.g., the processor 210) may, based on the second user input, play a video in at least a portion of the first image frame, and select a still image corresponding to a scene of the played video. In an embodiment, the electronic device 200 (e.g., the processor 210) may replace the corresponding area of the first image frame with the selected still image. Embodiments of operation 1120 and operation 1125 will be described below with reference to FIGS. 13A, 13B, 15, 16A, 16B, 22A, 22B, 22C, and 22D.

In operation 1130, the electronic device 200 (e.g., the processor 210) may determine whether a third user input (e.g., a touch, a flick, and/or a drag) for requesting a scene movement is received through a scene movement interface (e.g., the scene movement interface 1238a or 1238b) in the second editing interface. In case that the third user input for requesting a scene movement is received, the electronic device 200 (e.g., the processor 210) may proceed to operation 1135. In case that the third user input for requesting a scene movement is not received, the electronic device 200 (e.g., the processor 210) may proceed to operation 1160.

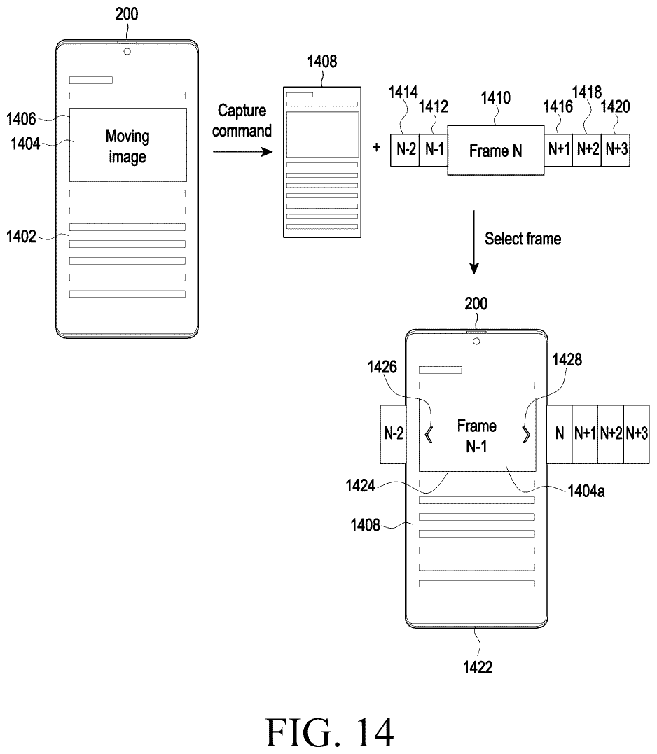

In operation 1135, the electronic device 200 (e.g., the processor 210) may display a still image of a corresponding area of the other image frames (not the first image frame) in at least a portion of the first image frame, based on the third user input, and may capture a still image of one of the other image frames. In an embodiment, the electronic device 200 (e.g., the processor 210) may replace the corresponding area of the first image frame with the captured still image. Embodiments of operation 1130 and operation 1135 will be described below with reference to FIGS. 14, 17, 18A, and 18B.

In operation 1140, the electronic device 200 (e.g., the processor 210) may determine whether a fourth user input (e.g., a touch, a flick, and/or a drag) requesting for area editing is received through the area editing interface (e.g., the area editing interface 1232, the area hiding interface 1912, or the area cutting interface 1914) in the second editing interface. In case that the fourth user input requesting area editing (e.g., area hiding or area cropping) is received, the electronic device 200 (e.g., the processor 210) may proceed to operation 1145. In case that the fourth user input requesting area editing is not received, the electronic device 200 (e.g., the processor 210) may proceed to operation 1160.

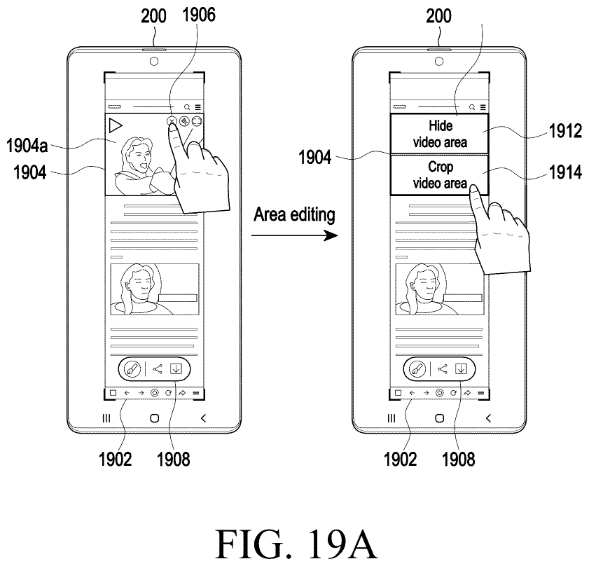

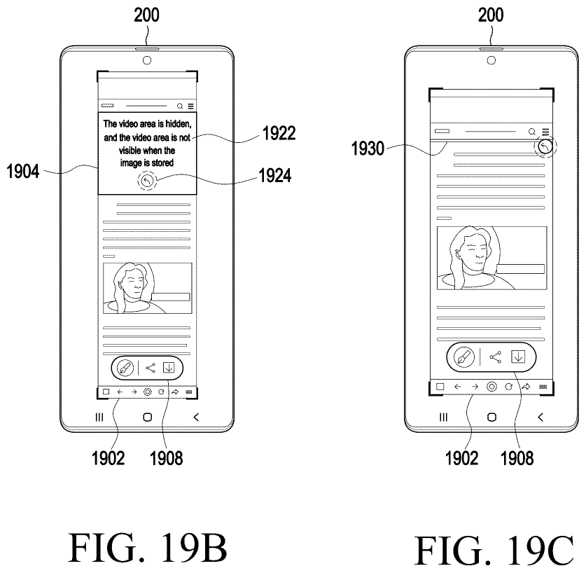

In operation 1145, the electronic device 200 (e.g., the processor 210) may, based on the third user input, replace the still image of at least a portion of the first image frame with designated information (e.g., a guiding message) or crop same. Embodiments of operation 1140 and operation 1145 will be described below with reference to FIGS. 19A, 19B, and 19C.

In operation 1150, the electronic device 200 (e.g., the processor 210) may determine whether a fifth user input (e.g., a touch, a flick, and/or a drag) requesting object editing is received through an object editing interface (e.g., at least one of the object editing interface 1234, the object deleting interface 2012, or the object changing interface 2112) within the second editing interface. In case that the fifth user input requesting object editing (e.g., object deletion or object change) is received, the electronic device 200 (e.g., the processor 210) may proceed to operation 1155. In case that the fifth user input requesting object editing is not received, the electronic device 200 (e.g., the processor 210) may proceed to operation 1160.

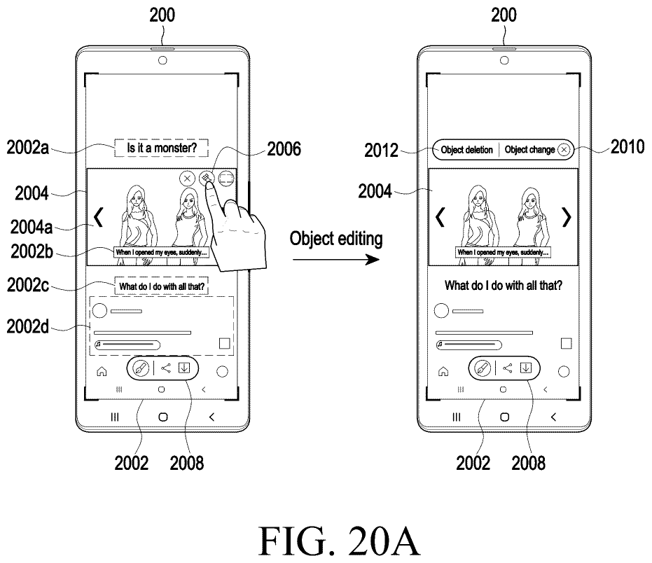

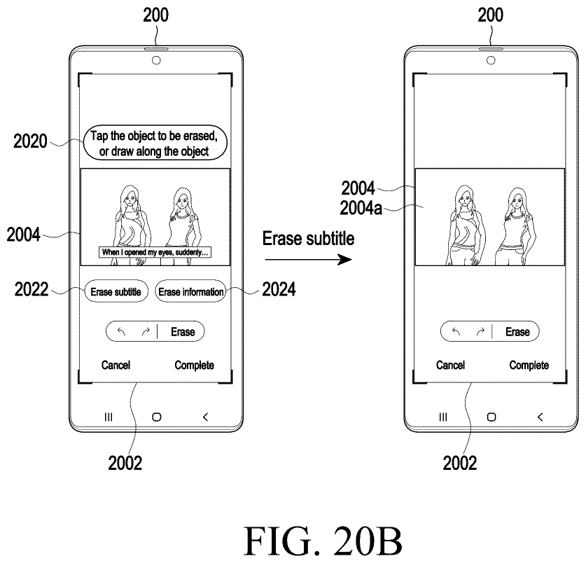

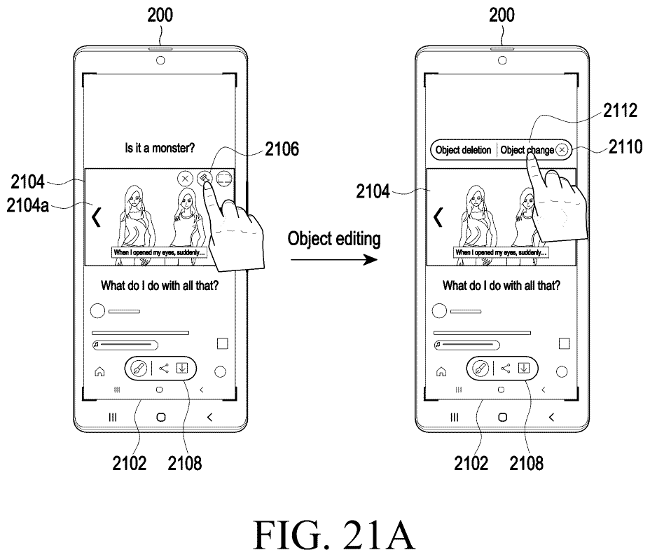

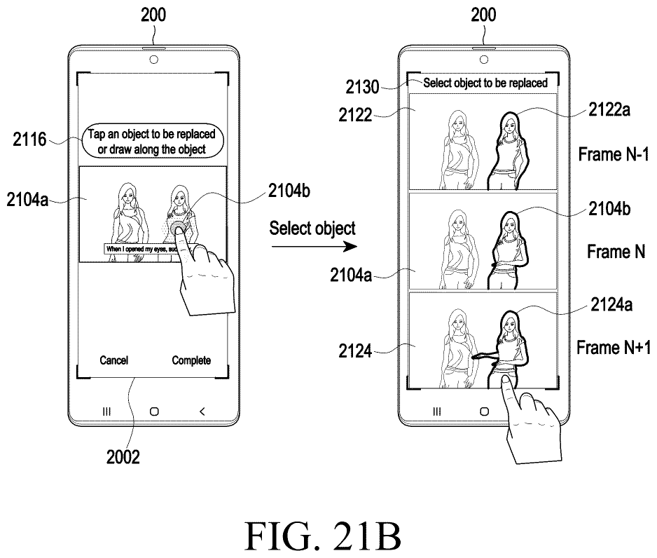

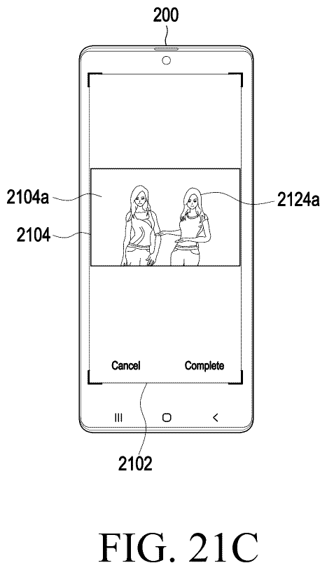

In operation 1155, the electronic device 200 (e.g., the processor 210) may, based on the fifth user input, delete at least one object included in at least a portion of the first image frame, or may replace same with an object obtained from a corresponding area of another image frame. Embodiments of operation 1150 and operation 1155 will be described below with reference to FIGS. 20A, 20B, 21A, 21B, and 21C.

The electronic device 200 (e.g., the processor 210) may proceed to operation 1160 after operation 1125, 1135, 1145, or 1155, or may again perform at least one of operation 1125, 1135, 1145, or 1155 (not illustrated).

In operation 1160, the electronic device 200 (e.g., the processor 210) may store an image file including the first image frame having been edited through at least one of operation 1125, 1135, 1145, or 1155.

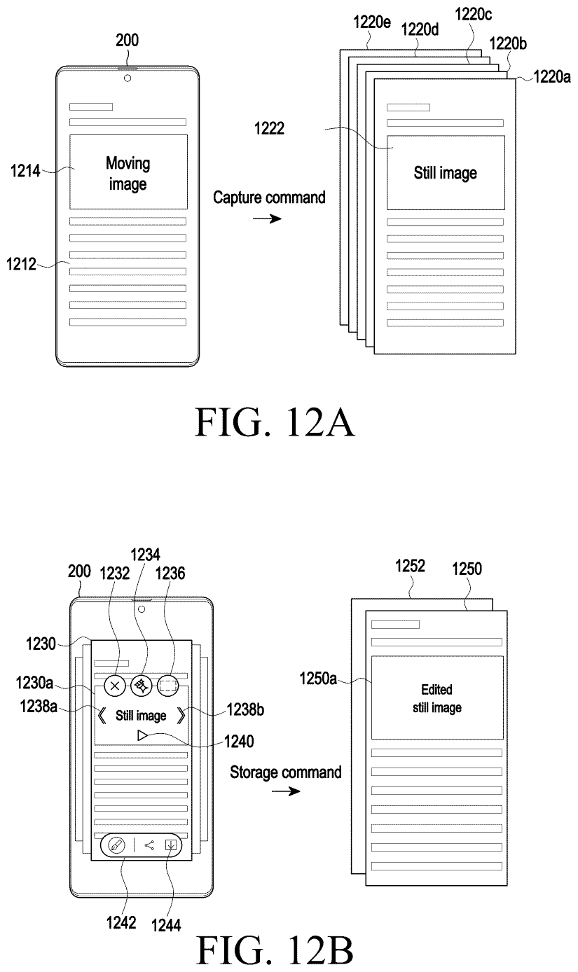

FIGS. 12A and 12B are diagrams illustrating an editing interface for image frames according to various embodiments of the disclosure.

Referring to FIG. 12A, the electronic device 200 (e.g., the processor 210) may display a first screen 1212 including a moving image 1214 through the display module 230. In an embodiment, the moving image 1214 may refer to an area in which a video or a moving image is played, or an area in which a video or an animated image is played on a web page.

In response to receiving the screen capture command, the electronic device 200 (e.g., the processor 210) may capture a plurality of image frames (e.g., a plurality of image frames 1220a, 1220b, 1220c, 1220d, and 1220e). In an embodiment, the plurality of image frames 1220a, 1220b, 1220c, 1220d, and 1220e may include still images (e.g., a still image 1222) captured from the first screen 1212 at a plurality of time points (e.g., consecutive capturing time points) including a current time point N when the screen capture command is received. For example, the plurality of image frames 1220a, 1220b, 1220c, 1220d, and 1220e may include not only a still image (e.g., a still image 1222) captured from an image frame at the current time point, but also one or more image frames before the current time point and/or one or more image frames after the current time point.

The electronic device 200 (e.g., the processor 210) may identify at least one image frame (e.g., the first image frame 1220a) selected from the plurality of image frames 1220a, 1220b, 1220c, 1220d, and 1220e as an object to be edited or an object to be captured. In an embodiment, the first image frame 1220a may be selected from the plurality of image frames 1220a, 1220b, 1220c, 1220d, and 1220e, based on a user input or an image difference.

The electronic device 200 (e.g., the processor 210) may display, through the display module 230, at least one thumbnail image (e.g., a first thumbnail image 1230) corresponding to the first image frame 1220a. In an embodiment, the electronic device 200 (e.g., the processor 210) may activate (e.g., highlight) and display the first thumbnail image 1230 and may deactivate and display thumbnail images corresponding to the remaining image frames 1220b, 1220c, 1220d, and 1220e. In an embodiment, the first thumbnail image 1230 may be displayed while covering the majority of the remaining thumbnail images. In an embodiment, the thumbnail images corresponding to the remaining image frames 1220b, 1220c, 1220d, and 1220e may be displayed in a blurred manner.

Referring to FIG. 12B, the electronic device 200 (e.g., the processor 210) may display at least one of, for example, the playback interface 1240, the scene movement interface 1238a or 1238b, the area editing interface 1232, the object editing interface 1234, or the area selection interface 1236 as an editing interface (e.g., the second editing interface) for an area 1230a including a still image 1220b captured from a moving image 1214 in a first image frame 1220a. In an embodiment, at least one of the playback interface 1240, the scene movement interface 1238a or 1238b, the area editing interface 1232, the object editing interface 1234, or the area selection interface 1236 may be displayed at least partially overlapping the area 1230a including the captured still image 1220b. The electronic device 200 (e.g., the processor 210) may also display a third editing interface 1242 including at least one of a pen input interface, a sharing interface, or a storage interface 1244, in addition to the first thumbnail image 1230. The third editing interface 1242 may be displayed at least partially overlapping the first thumbnail image 1230.

The electronic device 200 (e.g., the processor 210) may edit the still image 1222 in the area 1230a, based on one or more user inputs received through at least one of the playback interface 1240, the scene movement interface 1238a or 1238b, the area editing interface 1232, the object editing interface 1234, or the area selection interface 1236. The electronic device 200 (e.g., the processor 210) may store at least one image frame (e.g., an image frame 1250 and an image frame 1252) including the edited still image (e.g., a still image 1250a), based on receiving a user input through the storage interface 1244 in the third editing interface 1242. For example, the image frame 1250 may be generated by replacing the still image 1222 of the first image frame 1220a with the edited still image 1250a.

FIGS. 13A, 13B, and 13C are diagrams illustrating an editing interface according to various embodiments of the disclosure.

Referring to FIG. 13A, when displaying, based on a screen capture command, the image frame (e.g., the first image frame 1220a) captured from a screen (e.g., the first screen 1212) including a moving image (e.g., the moving image 1214) through the display module 230, the electronic device 200 (e.g., the processor 210) may display a playback interface 1304 in an area 1302 including a still image (e.g., image frame #1 1308) captured from the moving image (e.g., the moving image 1214). In an embodiment, image frame #1 1308 may include a scene of a video being played in a designated area 1302 of a screen (e.g., the first screen 1212) when a screen capture command is received. In another embodiment, the playback interface 1304 may be displayed outside the area 1302, or may be displayed so as to at least partially overlap the area 1302.

In an embodiment, the electronic device 200 (e.g., the processor 210) may display, through the display module 230, an editing interface 1306 including at least one of an area editing interface (e.g., an area editing interface 1322), an object editing interface (e.g., an object editing interface 1324), or an area selection interface (e.g., an area selection interface 1326) together with the area 1302.

The electronic device 200 (e.g., the processor 210) may play the moving image 1214 (e.g., a video) within the area 1302, based on detecting a user input (e.g., a touch) on the playback interface 1304. In an embodiment, the electronic device 200 (e.g., the processor 210) may play a video clip file extracted from the moving image 1214 (e.g., a video) based on a screen capture command, instead of playing the original of the moving image 1214 (e.g., a video). In an embodiment, the video clip file may include video data (e.g., image frames) during a designated time period including a time point when the screen capture command is received. In an embodiment, the electronic device 200 (e.g., the processor 210) may display the playback interface 1304 in the area 1302, based on identifying that the video clip file extracted based on the screen capture command has been stored.

The electronic device 200 (e.g., the processor 210) may display, through the display module 230, a pause interface 1304a during playback of the moving image 1214 (e.g., a video) in the area 1302. The pause interface 1304a may be displayed to replace the playback interface 1304 within the area 1302. The electronic device 200 (e.g., the processor 210) may display one scene (e.g., image frame #3 1310) of the moving image 1214 in the area 1302, based on detecting a user input (e.g., a touch) on the pause interface 1304a while playing the moving image 1214 (e.g., a video) in the area 1302.

The electronic device 200 (e.g., the processor 210) may replace a scene (e.g., image frame #1 1308) of the designated area 1302 in one (e.g., the first image frame 1220a) of the plurality of captured image frames with a selected another scene (e.g., image frame #3 1310), by using the playback interface 1304 and the pause interface 1304a. Based on receiving a user input (e.g., a touch on the area selection interface 1326 in the editing interface 1306) for ending the area editing, the electronic device 200 (e.g., the processor 210) may store the first image frame 1220a including the selected another scene (e.g., image frame #3 1310) in the area 1302.

Referring to FIG. 13B, when displaying, based on a screen capture command, the image frame (e.g., the first image frame 1220a) captured from a screen (e.g., the first screen 1212) including a moving image (e.g., the moving image 1214) through the display module 230, the electronic device 200 (e.g., the processor 210) may display a scene movement interface (e.g., a previous scene interface 1312a and a next scene interface 1312b) in an area 1312 including a still image (e.g., image frame #1 1314) captured from the moving image (e.g., the moving image 1214). For example, the previous scene interface 1312a may include a left-direction arrow image symbol, and the next scene interface 1312b may include a right-direction arrow image symbol.

In an embodiment, image frame #1 1314 may include a scene of an animated image being played in a designated area 1312 of a screen (e.g., the first screen 1212) when a screen capture command is received. As another embodiment, the scene movement interface (e.g., the previous scene interface 1312a and the next scene interface 1312b) may be displayed outside of the area 1312, or may be displayed at least partially overlapping the area 1312. In an embodiment, the electronic device 200 (e.g., the processor 210) may display, through the display module 230, an editing interface 1306 including at least one of an area editing interface (e.g., an area editing interface 1322), an object editing interface (e.g., an object editing interface 1324), or an area selection interface (e.g., an area selection interface 1326) together with the area 1312.

The electronic device 200 (e.g., the processor 210) may display a next scene (e.g., image frame #2 1316) of the moving image 1214 (e.g., a video or an animated image) in the area 1312, based on detecting a user input (e.g., a touch) on the next scene interface 1312b. In an embodiment, the electronic device 200 (e.g., the processor 210) may display, within the area 1312, a still image within the area 1312 of a next image frame (e.g., the second image frame 1220b) of the first image frame 1220a among the plurality of frames captured according to the screen capture command, as the next scene (e.g., image frame #2 1316).

The electronic device 200 (e.g., the processor 210) may display a previous scene (not shown) of the moving image 1214 (e.g., a video or an animated image) in the area 1312, based on detecting a user input (e.g., a touch) on the previous scene interface 1312a. In an embodiment, the electronic device 200 (e.g., the processor 210) may display, in the area 1312, a still image (not shown) in the area 1312 of the previous image frame of the first image frame 1220a, among the plurality of image frames captured according to the screen capture command, as the previous scene.

The electronic device 200 (e.g., the processor 210) may replace a scene (e.g., image frame #1 1314) of the designated area 1312 in one (e.g., the first image frame 1220a) of the plurality of captured image frames with a selected another scene (e.g., image frame #2 1316), by using the previous scene interface 1312a and the next scene interface 1312b. Based on receiving a user input (e.g., a touch on the area selection interface 1326 in the editing interface 1306) for ending the area editing, the electronic device 200 (e.g., the processor 210) may store the first image frame 1220a including the selected another scene (e.g., image frame #2 1316) in the area 1312.

Referring to FIG. 13C, when displaying, based on a screen capture command, the image frame (e.g., the first image frame 1220a) captured from a screen (e.g., the first screen 1212) including a moving image (e.g., the moving image 1214) through the display module 230, the electronic device 200 (e.g., the processor 210) may display the editing interface 1306 including at least one of an area editing interface 1322, an object editing interface 1324, and an area selection interface 1326 within an area 1320 including a still image (e.g., image frame #1 1314) captured from the moving image (e.g., the moving image 1214).

Description of embodiments of the area editing interface 1322, the object editing interface 1324, or the area selection interface 1326 included in the editing interface 1306 will be given below with reference to FIGS. 19A, 19B, 19C, 20A, 20B, 21A, 21B, 21C, 22A, 22B, 22C, and 22D.

FIG. 14 is a diagram illustrating a scene transition of a moving image according to an embodiment of the disclosure.

Referring to FIG. 14, the electronic device 200 (e.g., the processor 210) may display, through the display module 230, a screen (e.g., a first screen 1402) including a moving image 1404 (e.g., a video or an animated image) in a designated area 1406. Based on receiving a screen capture command while displaying the first screen 1402, the electronic device 200 (e.g., the processor 210) may capture a first image 1408 including a remaining portion except for the area 1406 of the first screen 1402, and may also capture a plurality of image frames 1410, 1412, 1414, 1416, 1418, and 1420 from the moving image 1404 in the area 1406.

In an embodiment, the screen capture command may include at least one user input for the screen capture command. For example, the screen capture command may be received by the electronic device 200 through a first button (e.g., a volume-down button) and a second button (e.g., a power button) designated for screen capture. The electronic device 200 (e.g., the processor 210) may start capturing the first screen 1402 based on detecting that the first button (e.g., a volume-down button) is pressed, and may store the captured first image 1408 and at least one image frame (e.g., image frames 1410, 1412, 1414) as temporary files. For example, the screen capture command may be received by the electronic device 200 through a long touch with respect to a designated button (e.g., an object displayed through the display module 230). The electronic device 200 (e.g., the processor 210) may start capturing the first screen 1402, based on detecting that the long touch on the designated button has started, and may store the captured first image 1408 and at least one image frame (e.g., the image frames 1410, 1412, and 1414) as temporary files.

The electronic device 200 (e.g., the processor 210) may capture the plurality of image frames 1410, 1412, 1414, 1416, 1418, and 1420 until the second button (e.g., a volume-down button) is pressed or until a long touch on a designated button is ended. In an embodiment, the plurality of image frames 1410, 1412, 1414, 1416, 1418, and 1420 may include an image frame 1410 at a current time point N at which a screen capture command is received, image frames 1412 and 1414 at previous time points N−1 and N−2, and image frames 1416, 1418, and 1420 at subsequent time points N+1, N+2, and N+3.

The electronic device 200 (e.g., the processor 210) may display the selected at least one image frame (e.g., image frame N−1 1412) among the plurality of image frames 1410, 1412, 1414, 1416, 1418, and 1420 and the first image 1408 through the display module 230. The image frame N−1 1412 may be displayed in a designated area (e.g., the area 1406).

In an embodiment, the electronic device 200 (e.g., the processor 210) may select the image frame N−1 1412, among the plurality of image frames 1410, 1412, 1414, 1416, 1418, and 1420, based on image difference values. Image frame N−1 1412 may include a still image 1404a captured from the moving image 1404 at time point N−1, within the designated area 1424.

As another embodiment, the electronic device 200 (e.g., the processor 210) may display the image frame N−1 1412 together with other image frames 1410, 1414, 1416, 1418, and 1420 through the display module 230, and may display the image frame N−1 1412 so as to be visually distinguishable from the other image frames 1410, 1414, 1416, 1418, and 1420. For example, the image frame N−1 1412 may be displayed with a larger size than other image frames 1410, 1414, 1416, 1418, and 1420. For example, image frame N−1 1412 may be displayed to overlap the other image frames 1410, 1414, 1416, 1418, and 1420.

The electronic device 200 (e.g., the processor 210) may display a scene movement interface (e.g., a previous scene interface 1426 and a next scene interface 1428) for moving between image frame N−1 1412 and a plurality of other image frames 1410, 1414, 1416, 1418, and 1420 within the designated area 1406, through the display module 230. In an embodiment, the previous scene interface 1426 and the next scene interface 1428 may be displayed to overlap the image frame N−1 1412. In another embodiment, the previous scene interface 1426 and the next scene interface 1428 may be displayed outside the designated area 1406 corresponding to the image frame N−1 1412, or may be displayed to at least partially overlap the image frame N−1 1412.

The electronic device 200 (e.g., the processor 210) may, based on a user input (e.g., a touch) received on the previous scene interface 1426 or the next scene interface 1428, replace the image frame N−1 1412 in the designated area 1406 with a previous image frame (e.g., the image frame N−2 1414) or a next image frame (e.g., the image frame N 1410) for display. In an embodiment, the electronic device 200 (e.g., the processor 210) may move the image frame N−1 1412 in a direction indicated by the previous scene interface 1426 or the next scene interface 1428, and then may move the previous image frame (e.g., the image frame N−2 1414) or the next image frame (e.g., the image frame N 1410).

The electronic device 200 (e.g., the processor 210) may store a screen 1422 including the first image 1408 and an image frame (e.g., image frame N−1 1412) selected by the previous scene interface 1426 or the next scene interface 1428 as a single image file. The image frame N−1 1412 may be included in the designated area 1406 of the first image 1408.

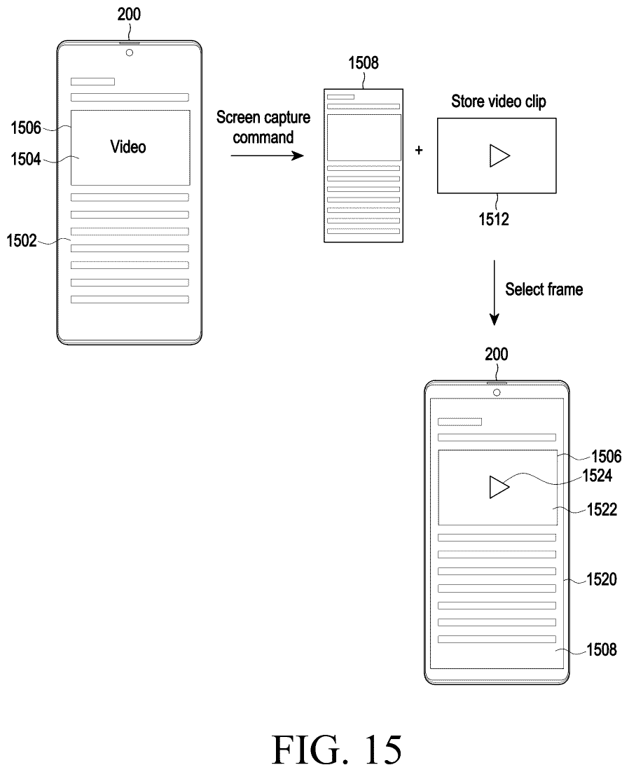

FIG. 15 is a diagram illustrating a scene transition of a video according to an embodiment of the disclosure.

Referring to FIG. 15, the electronic device 200 (e.g., the processor 210) may display, through the display module 230, a screen (e.g., a first screen 1502) including a moving image (e.g., a video 1504). The electronic device 200 (e.g., the processor 210) may identify an area 1506 including the moving image (e.g., the video 1504) within the first screen 1502. Based on receiving a screen capture command while displaying the first screen 1502, the electronic device 200 (e.g., the processor 210) may capture a first image 1508 including a remaining portion except for the area 1506 of the first screen 1502, and may also obtain a video clip file 1512 corresponding to the video 1504 in the area 1506. In an embodiment, the screen capture command may include a user input through at least one physical button, or a user input through an object displayed through the display module 230.

In an embodiment, the first screen 1502 may include a web page provided by a web browser application, and the electronic device 200 (e.g., the processor 210) may identify that the web page includes an area (e.g., the area 1506) in which a video is being played, based on the screen capture command. In an embodiment, the electronic device 200 (e.g., the processor 210) may determine that the web page includes an area (e.g., the area 1506) in which a video is played, based on a source code of the web page including a file extension of the video file. The electronic device 200 (e.g., the processor 210) may download a video clip file (e.g., the video clip file 1512) corresponding to the video from a server (not shown) by using the source code of the web page.

The electronic device 200 (e.g., the processor 210) may display the first image 1508 and a still image (e.g., still image N−1 1522) including a scene of the video clip file 1512 through the display module 230. Still image N−1 1522 may be displayed in a designated area (e.g., the area 1506). In an embodiment, the electronic device 200 (e.g., the processor 210) may select still image N−1 1522 including a scene representing the video clip file 1512.

The electronic device 200 (e.g., the processor 210) may display, through the display module 230, a playback interface 1524 for playing the video clip file 1512 in the designated area 1506. In an embodiment, the playback interface 1524 may be displayed overlapping still image N−1 1522. In another embodiment, the playback interface 1524 may be displayed outside the designated area 1506 corresponding to still image N−1 1522, or may be displayed at least partially overlapping still image N−1 1522.

Based on receiving a user input (e.g., a touch) on the playback interface 1524, the electronic device 200 (e.g., the processor 210) may play the video clip file 1512 within the designated area 1506 corresponding to still image N−1 1522. The electronic device 200 (e.g., the processor 210) may play the video clip file 1512 in the designated area 1506, stop the playback of the video clip file 1512 at a desired scene (e.g., still image N−1 1522), and store the screen 1520 including the desired scene (e.g., still image N−1 1522) and the first image 1508 as a single image file.

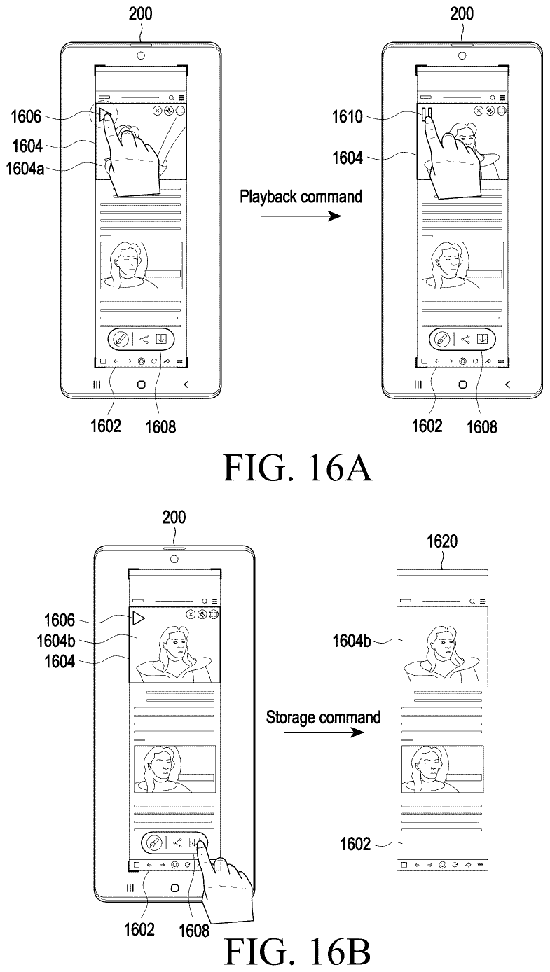

FIGS. 16A and 16B are diagrams illustrating an operation of selecting a desired scene by using a video clip file according to various embodiments of the disclosure.

Referring to FIG. 16A, the electronic device 200 (e.g., the processor 210) may display, through the display module 230, a first image frame 1602 including an area 1604 corresponding to a video being played (e.g., the video 1504), based on receiving a screen capture command. The electronic device 200 (e.g., the processor 210) may display a still image 1604a that represents a scene of the video (e.g., the video 1504) within the area 1604 of the first image frame 1602. The electronic device 200 (e.g., the processor 210) may display a playback interface 1606 for playing a video clip file corresponding to the video within the area 1604 of the first image frame 1602.

The electronic device 200 (e.g., the processor 210) may display an editing interface 1608 together with the first image frame 1602. The editing interface 1608 may include at least one of a pen input interface, a sharing interface, or a storage interface. The editing interface 1608 may be displayed at least partially overlapping the first image frame 1602, or may be displayed outside the first image frame 1602.

The electronic device 200 (e.g., the processor 210) may play a video clip file (e.g., the video clip file 1512) corresponding to the video (e.g., the video 1504) within the area 1604, based on a user input (e.g., a touch) received on the playback interface 1606. In an embodiment, the electronic device 200 (e.g., the processor 210) may download a video clip file (e.g., the video clip file 1512) from a server (not shown) based on a screen capture command.

The electronic device 200 (e.g., the processor 210) may display a pause interface 1610 through the display module 230 while playing the video clip file (e.g., the video clip file 1512) within the area 1604. In an embodiment, the pause interface 1610 may be displayed within the area 1604, or may be displayed to at least partially overlap the area 1604. The electronic device 200 (e.g., the processor 210) may pause the playback of the video clip file (e.g., the video clip file 1512) within the area 1604, and display a still image 1604b including a scene of the video clip file within the area 1604, based on receiving a user input (e.g., a touch) on the pause interface 1610.

Referring to FIG. 16B, the electronic device 200 (e.g., the processor 210) may receive a user input (e.g., a touch) through a storage interface of the editing interface 1608 while playback of a video clip file (e.g., the video clip file 1512) is temporarily paused. The electronic device 200 (e.g., the processor 210) may, based on the user input through the storage interface, store the first image frame 1602 including the still image 1604b within the area 1604 as an image file 1620.

In an embodiment, the electronic device 200 (e.g., the processor 210) may generate the image file 1620 including the still image 1604b displayed on the display module 230 at a time point at which a user input is received through the pause interface 1610, instead of the still image 1604a at the time at which the screen capture command is received.

In an embodiment, in case that the first image frame 1602 includes one or more areas corresponding to moving images (e.g., the video 1504 and/or the moving image 1404), the electronic device 200 (e.g., the processor 210) may perform the operations described with reference to FIGS. 16A and 16B for each of the one or more areas.

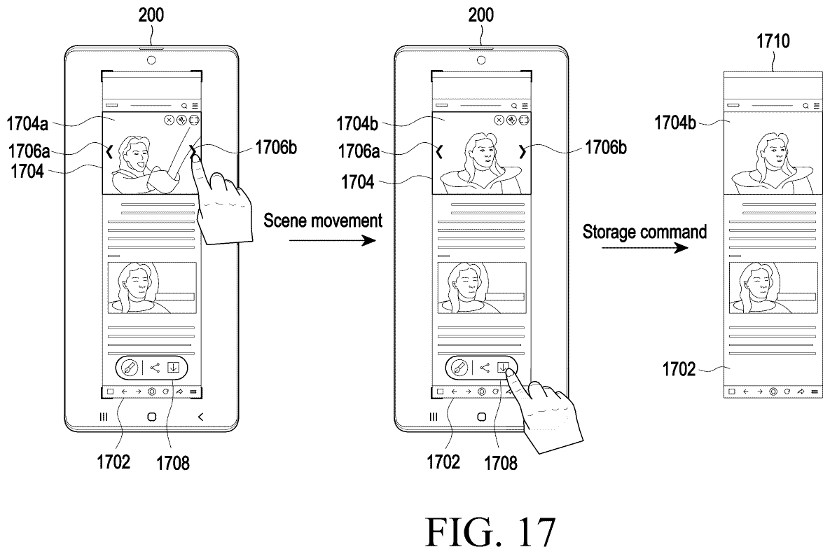

FIG. 17 is a diagram illustrating an operation of selecting a desired scene through a scene transition according to an embodiment of the disclosure.

Referring to FIG. 17, the electronic device 200 (e.g., the processor 210) may display, through the display module 230, a first image frame 1702 including an area 1704 corresponding to a moving image (e.g., the moving image 1404), based on receiving a screen capture command. The electronic device 200 (e.g., the processor 210) may display one still image 1704a (e.g., image frame #N) selected from among a plurality of still images (not shown) captured from the moving image 1404 within the area 1704 of the first image frame 1702. The electronic device 200 (e.g., the processor 210) may display a scene movement interface (e.g., a previous scene interface 1706a and a next scene interface 1706b) for sequentially displaying the plurality of still images captured from the moving image 1404 within the area 1704 of the first image frame 1702.

The electronic device 200 (e.g., the processor 210) may display an editing interface 1708 together with the first image frame 1702. The editing interface 1708 may include at least one of a pen input interface, a sharing interface, or a storage interface. The editing interface 1708 may be displayed at least partially overlapping the first image frame 1702, or may be displayed outside the first image frame 1702.

The electronic device 200 (e.g., the processor 210) may display a still image 1704b (e.g., image frame #N+1) corresponding to a next scene of the still image 1704a within the area 1704, based on a user input (e.g., a touch) received on the next scene interface 1706b.

The electronic device 200 (e.g., the processor 210) may receive a user input (e.g., a touch) through a storage interface of the editing interface 1708 during while the still image 1704b is displayed within the area 1704. The electronic device 200 (e.g., the processor 210) may, based on the user input through the storage interface, store the first image frame 1702 including the still image 1704b within the area 1704 as an image file 1710.

In an embodiment, the electronic device 200 (e.g., the processor 210) may generate the image file 1710 including the still image 1704b selected, based on a user input through the scene movement interface (e.g., the previous scene interface 1706a and the next scene interface 1706b), instead of the still image 1704a at the time point at which the screen capture command is received.

In an embodiment, in case that the first image frame 1702 includes one or more areas corresponding to moving images (e.g., the video 1504 and/or the moving image 1404), the electronic device 200 (e.g., the processor 210) may perform the operations described with reference to FIG. 17 for each of the one or more areas.

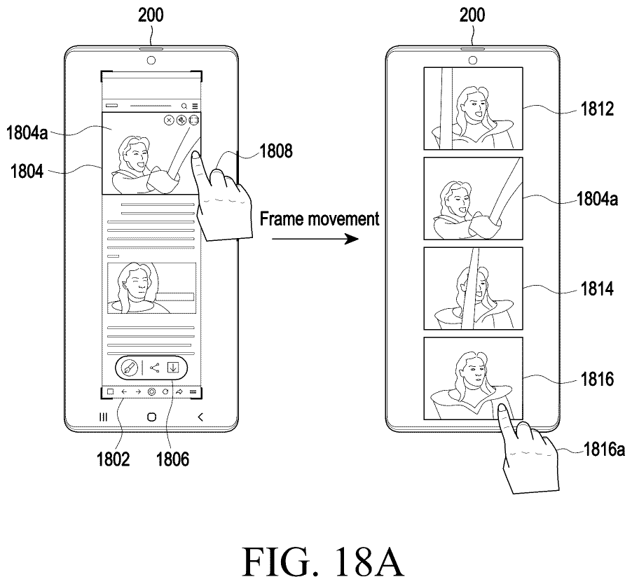

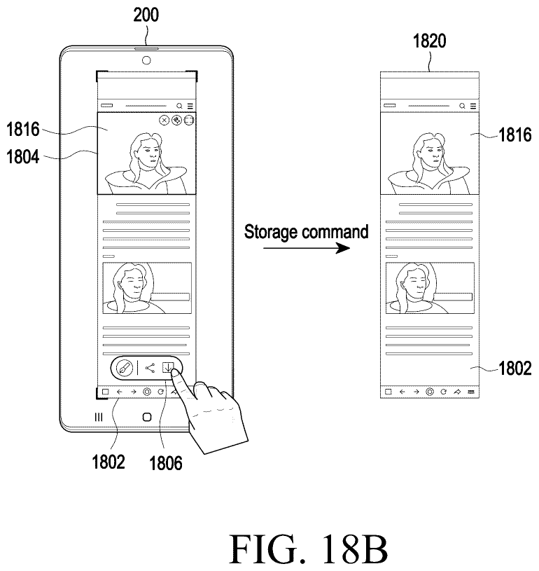

FIGS. 18A and 18B are diagrams illustrating an operation of selecting a desired scene among a plurality of scenes listed according to various embodiments of the disclosure.

Referring to FIG. 18A, the electronic device 200 (e.g., the processor 210) may display, through the display module 230, a first image frame 1802 including an area 1804 corresponding to a moving image (e.g., the moving image 1404), based on receiving a screen capture command. The electronic device 200 (e.g., the processor 210) may display one still image 1804a (e.g., image frame #N) selected from among a plurality of still images (not shown) captured from the moving image 1404 within the area 1804 of the first image frame 1802.

The electronic device 200 (e.g., the processor 210) may receive a user input 1808 for listing the plurality of still images captured from the moving image 1404, during displaying the first image frame 1802 including the area 1804. In an embodiment, the user input 1808 may include a long touch or a double touch with respect to the area 1804 in which a scene replacement is desired.

The electronic device 200 (e.g., the processor 210) may display an editing interface 1806 together with the first image frame 1802. The editing interface 1806 may include at least one of a pen input interface, a sharing interface, or a storage interface. The editing interface 1806 may be displayed at least partially overlapping the first image frame 1802, or may be displayed outside the first image frame 1802.

Based on receiving the user input 1808, the electronic device 200 (e.g., the processor 210) may list the still image 1804a and subsequent still images (e.g., still images 1812, 1814, and 1806) to display same through the display module 230. In an embodiment, the electronic device 200 (e.g., the processor 210) may display a still image 1812 (e.g., image frame #N−1) on one side (e.g., the top) of a still image 1804a (e.g., image frame #N), and display still images 1814 and 1816 (e.g., image frames #N+1 and #N+2) on the other side (e.g., the bottom) of the still image 1804a (e.g., image frame #N).

In an embodiment, the electronic device 200 (e.g., the processor 210) may display the still images 1812, 1804a, 1814, and 1816 to overlap each other on the first image frame 1802. The still images 1812, 1804a, 1814, and 1816 may be arranged not to overlap each other, or may be arranged to be at least partially overlap each other. While the still images 1812, 1804a, 1814, and 1816 are displayed, a remaining portion of the first image frame 1802 which is not covered by the still images 1812, 1804a, 1814, and 1816 may be displayed in a blurred manner.

In an embodiment, the electronic device 200 (e.g., the processor 210) may proceed to FIG. 18B, based on receiving a user input 1816a (e.g., a touch) on one of the still images 1812, 1804a, 1814, and 1816 (e.g., the still image 1816).

Referring to FIG. 18B, the electronic device 200 (e.g., the processor 210) may, based on receiving the user input 1816a, display the first image frame 1802 including the still image 1816 selected by the user input 1816a in the area 1804, through the display module 230. The electronic device 200 (e.g., the processor 210) may display an editing interface 1806 together with the first image frame 1802 including the still image 1816.

The electronic device 200 (e.g., the processor 210) may receive a user input (e.g., a touch) through the storage interface of the editing interface 1806. The electronic device 200 (e.g., the processor 210) may, based on the user input through the storage interface, store the first image frame 1802 including the still image 1816 within the area 1804 as an image file 1820.

In an embodiment, the electronic device 200 (e.g., the processor 210) may generate the image file 1820 including the still image 1816 (e.g., image frame #N+2) selected, based on a user input (e.g., the user input 1816a), from among the listed still images 1812, 1804a, 1814, and 1816, instead of the still image 1804a (e.g., image frame #N) at the time point when the screen capture command is received.

In an embodiment, in case that the first image frame 1802 includes one or more areas corresponding to moving images (e.g., the video 1504 and/or the moving image 1404), the electronic device 200 (e.g., the processor 210) may perform the operations described with reference to FIGS. 18A and 18B for each of the one or more areas.

FIGS. 19A, 19B, and 19C are diagrams illustrating an operation of editing an area corresponding to a moving image according to various embodiments of the disclosure.

Referring to FIG. 19A, the electronic device 200 (e.g., the processor 210) may display, through the display module 230, a first image frame 1902 including an area 1904 corresponding to a moving image (e.g., the moving image 1404 or the video 1504), based on receiving a screen capture command. The electronic device 200 (e.g., the processor 210) may display one still image 1904a (e.g., image frame #N) selected from among a plurality of still images (not shown) captured from the moving image 1404 or the video 1504 within the area 1904 of the first image frame 1902.

The electronic device 200 (e.g., the processor 210) may display an editing interface 1908 together with the first image frame 1902. The editing interface 1908 may include at least one of a pen input interface, a sharing interface, or a storage interface. The editing interface 1908 may be displayed at least partially overlapping the first image frame 1902, or may be displayed outside the first image frame 1902.

While displaying the first image frame 1902 including the area 1904, the electronic device 200 (e.g., the processor 210) may display an area editing interface 1906 for editing the area 1904 through the display module 230. In an embodiment, the area editing interface 1906 may include an image symbol and may be displayed overlapping the area 1904, or may be displayed at least partially overlapping the area 1904.

The electronic device 200 (e.g., the processor 210) may, based on receiving a user input (e.g., a touch) on the area editing interface 1906 associated with the area 1904, display at least one of an area hiding interface 1912 and an area cropping interface 1914 through the display module 230. In an embodiment, at least one of the area hiding interface 1912 and the area cropping interface 1914 may be displayed so as to overlap the area 1904 or may be displayed so as to partially overlap the area 1904. In an embodiment, the area editing interface 1906 may not be displayed through the display module 230 during at least one of the area hiding interface 1912 and the area cropping interface 1914 being displayed.

In an embodiment, the electronic device 200 (e.g., the processor 210) may proceed to FIG. 19B, based on receiving a user input (e.g., a touch) on the area hiding interface 1912. In an embodiment, the electronic device 200 (e.g., the processor 210) may proceed to FIG. 19C, based on receiving a user input (e.g., a touch) on the area cropping interface 1914.

Referring to FIG. 19B, the electronic device 200 (e.g., the processor 210) may display, within the area 1904, designated information 1922 and/or a restorage interface 1924 instead of the still image 1904a, based on receiving a user input on the area hiding interface 1912. As an embodiment, the designated information 1922 may include a designated expression, for example, “The video area is hidden, and the video area is not visible when the image is stored.” The electronic device 200 (e.g., the processor 210) may replace the designated information 1922 in the area 1904, for example, with a still image 1904a as in FIG. 9A, based on receiving a user input (e.g., a touch) through the restorage interface 1924.

The electronic device 200 (e.g., the processor 210) may store the first image frame 1902 as an image file with the area 1904 empty, based on receiving a user input (e.g., a touch) through the storage interface in the editing interface 1908 during display of the designated information 1922 instead of the still image 1904a in the area 1904. In an embodiment, the area 1904 may be filled with a designated single color without an image frame or a text.

Referring to FIG. 19C, the electronic device 200 (e.g., the processor 210) may, based on receiving a user input on the area cropping interface 1914, control the display module 230 so that the area 1904 is not displayed, and may display designated information 1930 indicating that the area 1904 has been deleted (e.g., not displayed through the display module 230) and/or a restorage interface 1932. As an embodiment, instead of displaying the area 1904, designated information 1930 may include a bold line indicating a position at which the area 1904 has been deleted. The electronic device 200 (e.g., the processor 210) may, for example, again display the still image 1904a in the area 1904, as in FIG. 9A, based on receiving a user input (e.g., a touch) through the restorage interface 1932.

The electronic device 200 (e.g., the processor 210) may store the first image frame 1902 not including the area 1904 as an image file, based on receiving a user input (e.g., a touch) through the storage interface in the editing interface 1908 while the area 1904 is deleted and the designated information 1930 is displayed. In an embodiment, the first image frame 1902 may include, instead of the area 1904, the designated information 1930 (e.g., a bold line) for indicating that the area 1904 was present, or may simply include an image of a remaining area excluding the area 1904, without the area 1904.

FIGS. 20A and 20B are diagrams illustrating an operation of deleting objects of a captured image frame according to various embodiments of the disclosure.

Referring to FIG. 20A, the electronic device 200 (e.g., the processor 210) may display, through the display module 230, a first image frame 2002 including an area 2004 corresponding to a moving image (e.g., the moving image 1404 or the video 1504), based on receiving a screen capture command. The electronic device 200 (e.g., the processor 210) may display one still image 2004a (e.g., image frame #N) selected from among a plurality of still images (not shown) captured from the moving image 1404 or the video 1504 within the area 2004 of the first image frame 2002.

The electronic device 200 (e.g., the processor 210) may display an editing interface 2008 together with the first image frame 2002. The editing interface 2008 may include at least one of a pen input interface, a sharing interface, or a storage interface. The editing interface 2008 may be displayed at least partially overlapping the first image frame 2002, or may be displayed outside the first image frame 2002.

In an embodiment, the first image frame 2002 may include one or more objects related to the still image 2004a, which are located within or out of the area 2004 together with the area 2004 including the still image 2004a. In an embodiment, the objects may include at least one of at least one subtitle object (e.g., a subtitle object 2002a, a subtitle object 2002b, and a subtitle object 2002c), at least one description object (e.g., a description object 2002d including an uploader and/or a description of the video 1504), or one or more playback control objects (not shown) (e.g., a playback button, a pause button, a playback progress bar, or a menu button).

The electronic device 200 (e.g., the processor 210) may identify that a first image frame 2002 includes objects (e.g., subtitle objects 2002a, 2002b, and 2002c, and a description object 2002d) related to the area 2004, while displaying the first image frame 2002 including the area 2004. The electronic device 200 (e.g., the processor 210) may identify positions and sizes of the objects by, for example, a pre-stored AI algorithm.

While displaying the first image frame 2002 including the area 2004, the electronic device 200 (e.g., the processor 210) may display an AI editing interface 2006 through the display module 230. In an embodiment, the AI editing interface 2006 may be displayed overlapping the area 2004, or may be displayed to at least partially overlap the area 2004. The electronic device 200 (e.g., the processor 210) may display, through the display module 230, an object editing interface 2010 for editing the identified objects, based on receiving a user input on the AI editing interface 2006. In an embodiment, the object editing interface 2010 may be displayed overlapping the area 2004, or may be displayed to at least partially overlap the area 2004. In an embodiment, the object editing interface 2010 may include an object deleting interface 2012.

The electronic device 200 (e.g., the processor 210) may proceed to FIG. 20B, based on receiving a user input (e.g., a touch) on the object deleting interface 2012 of the object editing interface 2010 related to the area 2004.

Referring to FIG. 20B, the electronic device 200 (e.g., the processor 210) may display at least one interface (e.g., a subtitle erasing interface 2022 and/or an information erasing interface 2024) for designating an object to be deleted, based on receiving a user input on the object deleting interface 2012. In an embodiment, the subtitle erasing interface 2022 and/or the information erasing interface 2024 may be displayed so as to overlap the area 2004 or may be displayed so as to at least partially overlap the area 2004. While displaying at least one interface (e.g., the subtitle erasing interface 2022 and/or the information erasing interface 2024) for designating an object to be deleted, the electronic device 200 (e.g., the processor 210) may display, through the display module 230, a guiding text 2020 for object editing, for example, “Tap the object to be erased, or draw along the object.”

The electronic device 200 (e.g., the processor 210) may delete at least one subtitle object (e.g., the subtitle object 2002a, the subtitle object 2002b, and the subtitle object 2002c) identified in the first image frame 2002, based on a user input (e.g., a touch) received through the subtitle erasing interface 2022. The electronic device 200 (e.g., the processor 210) may delete at least one description object (e.g., the description object 2002d) identified in the first image frame 2002, based on a user input (e.g., a touch) received through the information erasing interface 2024. Although not illustrated, in an embodiment, the electronic device 200 (e.g., the processor 210) may highlight the identified at least one object (e.g., the subtitle objects 2002a, 2002b, 2002c, and the description object 2002d), and may receive a user input (e.g., a touch) for selecting at least one object to be deleted.

The electronic device 200 (e.g., the processor 210) may display the first image frame 2002 in which at least one object (e.g., at least one of the subtitle objects 2002a, 2002b, 2002c, or the description object 2002d) has been deleted. The first image frame 2002 may include the still image 2004a in the area 2004, but may not include at least one object selected by a user (e.g., at least one of subtitle objects 2002a, 2002b, 2002c or the description object 2002d). While displaying the first image frame 2002 in which at least one object (e.g., at least one of the subtitle objects 2002a, 2002b, 2002c, or the description object 2002d) has been deleted, the electronic device 200 (e.g., the processor 210) may, based on receiving a user input (e.g., a touch) through the storage interface in the editing interface 2008, store, as an image file, the first image frame 2002 including an edited area 2004 in which at least one object has been deleted.

FIGS. 21A, 21B, and 21C are diagrams illustrating an operation of changing objects of a captured image frame according to various embodiments of the disclosure.

Referring to FIG. 21A, the electronic device 200 (e.g., the processor 210) may display, through the display module 230, a first image frame 2102 including an area 2104 corresponding to a moving image (e.g., the moving image 1404 or the video 1504), based on receiving a screen capture command. The electronic device 200 (e.g., the processor 210) may display one still image 2104a (e.g., image frame #N) selected from among a plurality of still images (not shown) captured from the moving image (e.g., the moving image 1404 or the video 1504) within the area 2104 of the first image frame 2102.

The electronic device 200 (e.g., the processor 210) may display an editing interface 2108 together with the first image frame 2102. The editing interface 2108 may include at least one of a pen input interface, a sharing interface, or a storage interface. The editing interface 2108 may be displayed at least partially overlapping the first image frame 2102, or may be displayed outside the first image frame 2102.

While displaying the first image frame 2102 including the area 2104, the electronic device 200 (e.g., the processor 210) may display an AI editing interface 2106 through the display module 230. In an embodiment, the AI editing interface 2106 may be displayed overlapping the area 2104, or may be displayed to at least partially overlap the area 2104. The electronic device 200 (e.g., the processor 210) may display, through the display module 230, an object editing interface 2110 for editing at least one object included in the first image frame 2102, based on receiving a user input on the AI editing interface 2106. In an embodiment, the object editing interface 2110 may be displayed overlapping the area 2104, or may be displayed to at least partially overlap the area 2104. In an embodiment, the object editing interface 2110 may include an object changing interface 2112.

The electronic device 200 (e.g., the processor 210) may proceed to FIG. 21B, based on receiving a user input (e.g., a touch) on the object changing interface 2112 of the object editing interface 2110 related to the area 2104.

Referring to FIG. 21B, the electronic device 200 (e.g., the processor 210) may, based on receiving a user input on the object changing interface 2112, display a guidance message 2116 for object change, for example, “Tap an object to be replaced or draw along the object.” through the display module 230.

The electronic device 200 (e.g., the processor 210) may display a guidance message 2116, then receive a user input (e.g., a drawing or a long touch) for selecting an object to be replaced, and identify at least one object (e.g., a person object 2104b) of the still images 2104a in the area 2104, based on the user input. For example, the still image 2104a may include a plurality of person objects. In an embodiment, the electronic device 200 (e.g., the processor 210) may identify the person objects by using a pre-stored AI algorithm, and may display (e.g., by highlighting the outline) the identified person objects so that the identified person objects are visually distinguishable from each other. The electronic device 200 (e.g., the processor 210) may receive a user input (e.g., a touch or a long touch) for selecting one of the person objects (e.g., a person object 2104b) having a highlighted outline. In an embodiment, the electronic device 200 (e.g., the processor 210) may receive a user input (e.g., a drawing) tracing an outline of any one of the human objects (e.g., the human object 2104b).

The electronic device 200 (e.g., the processor 210) may list and display, through the display module 230, at least one still image (e.g., the still image 2104a, the still image 2122, and the still image 2124) that includes the object (e.g., an object 2122a and an object 2124a) corresponding to the identified object 2104b, among the plurality of still images captured from the moving image 1404 or the video 1504, based on identifying at least one object (e.g., the person object 2104b) to be replaced. The still image 2104a may correspond to image frame #N and may include the identified object 2104b. The still image 2122 may correspond to image frame #N−1, and may include the object 2122a corresponding to the identified object 2104b. The still image 2124 may correspond to image frame #N+1, and may include the object 2124a corresponding to the identified object 2104b. For example, the object 2122a and the object 2124a may be the same person as the identified object 2104b.

The electronic device 200 (e.g., the processor 210) may display, through the display module 230, the objects 2122a, 2104b, and 2124a in the still image 2104a, the still image 2122, and the still image 2124 to be visually distinguishable from other areas. In an embodiment, the objects 2122a, 2104b, and 2124a may be highlighted by a bold outline. In an embodiment, the remaining areas except for the objects 2122a, 2104b, and 2124a among the still image 2104a, the still image 2122, and the still image 2124 may be displayed to be blurred.

The electronic device 200 (e.g., the processor 210) may display, through the display module 230, the still image 2104a, the still image 2122, and the still image 2124, while displaying a guidance message 2130 for object replacement, for example, “Please select an object to replace.” The electronic device 200 (e.g., the processor 210) may receive, through at least one of the still image 2104a, the still image 2122, and the still image 2124, for example, through the still image 2124, a user input (e.g., a touch, a long touch, or a drag) for selecting the object 2124a within the still image 2124. The user may select the still image 2124 including an object (e.g., object 2124a) to be replaced from the listed still images (e.g., the still image 2104a, the still image 2122, and the still image 2124). For example, the user may identify that the object 2104b in the still image 2104 is blurred or the person has closed eyes, and select the object 2124a of the same person that is sharp or has not closed eyes.

Referring to FIG. 21C, the electronic device 200 (e.g., the processor 210) may replace the object 2104b of the still image 2104a with the selected object 2124a, based on reception of a user input (e.g., a touch for the still image 2124 or the object 2124a) for selecting the object 2124a within the still image 2124. The electronic device 200 (e.g., the processor 210) may display the first image frame 2102 including the edited still image 2104a within the area 2104 through the display module 230. The edited still image 2104a may include the selected object 2124a instead of the object 2104b. The electronic device 200 (e.g., the processor 210) may store the first image frame 2102 including the still image 2104a including the selected object 2124a as an image file, based on the user input.

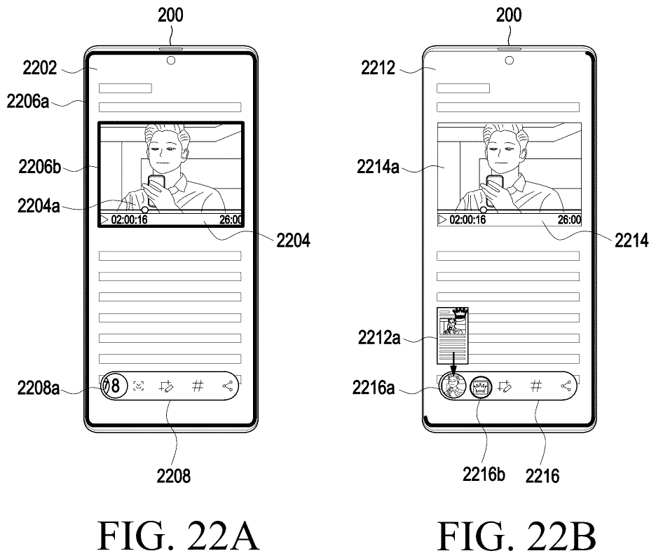

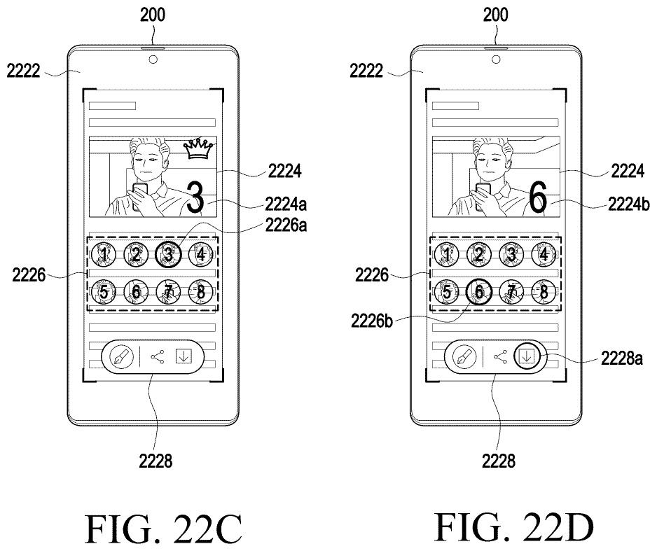

FIGS. 22A, 22B, 22C, and 22D are diagrams illustrating an operation of capturing a periphery of a video region according to various embodiments of the disclosure.

Referring to FIG. 22A, the electronic device 200 (e.g., the processor 210) may display a screen (e.g., a first screen 2202) including a video 2204a (e.g., a moving image 1404) being played through the display module 230. The electronic device 200 (e.g., the processor 210) may identify an area 2204 including a video 2204a being played within the first screen 2202. In an embodiment, the first screen 2202 may include information (e.g., at least a portion of a web page) generated by executing a web browser, and the video 2204a being played may be included in the web page or received by the electronic device 200 from an Internet link included in the web page. In an embodiment, the first screen 2202 may include information generated by execution of a camera application, a video player application, or a gallery application, and the area 2204 may occupy all or part of the first screen 2202.

Based on receiving a screen capture command while displaying the first screen 2202, the electronic device 200 (e.g., the processor 210) may capture a first image 1408 including a remaining portion except for the area 2204 of the first screen 2202, and may also capture a plurality of image frames (e.g., image frames 1410, 1412, 1414, 1416, 1418, and 1420) from the video being played within the area 2204. In an embodiment, the electronic device 200 (e.g., the processor 210) may consecutively capture the plurality of image frames from the video being played, based on a frame rate (frame per second, ps) of the video being played.

In an embodiment, when a screen capture command is input during display of the first screen 2202 including the video 2204a being played, the electronic device 200 (e.g., the processor 210) may display a first effect interface 2206a for capturing the entire first screen 2202 and a second effect interface 2206b for capturing the area 2204 corresponding to the video being played back. In an embodiment, at least one of the first effect interface 2206a or the second effect interface 2206b may include an outline that flickers or is temporarily contracted or expanded so as to surround the captured area (e.g., the entire first screen 2202 or the area 2204). In an embodiment, at least one of the first effect interface 2206a or the second effect interface 2206b may be repeatedly displayed each time each of the plurality of image frames is captured.

In an embodiment, the electronic device 200 (e.g., the processor 210) may display a first editing interface 2208, based on the screen capture command. The first editing interface 2208 may include at least one of a scroll capture interface, an area selection interface, tag insertion, or a sharing interface. The first editing interface 2208 may be displayed at least partially overlapping the first screen 2202 or displayed outside of the first screen 2202. The first editing interface 2208 may be displayed for a designated time period and then disappear (e.g., be removed) from the display module 230.

In an embodiment, the electronic device 200 (e.g., the processor 210) may display an interface (e.g., a high-speed capture animation interface 2208a) for counting the number of image frames captured during a process of consecutively capturing a designated number of image frames (e.g., the image frames 1410, 1412, 1414, 1416, 1418, and 1420) from the video 2204a being played, based on the screen capture command. In an embodiment, the high-speed capture animation interface 2208a may include a number inside the circle, and the count of the image frames being captured during the capturing of the plurality of image frames may be displayed in the circle in order, increasing from 1. For example, the electronic device 200 (e.g., the processor 210) may capture a designated number (e.g., 8) of image frames, and the high-speed capture animation interface 2208a may include numbers that increase in sequence from 1 to 8. In an embodiment, the high-speed capture animation interface 2208a may be included in the first editing interface 2208.

Referring to FIG. 22B, the electronic device 200 (e.g., the processor 210) may display, through the display module 230, a second screen 2212 including an area 2214 corresponding to an area 2204 including the video 2204a being played back, after the screen capture command has been performed. In an embodiment, the electronic device 200 (e.g., the processor 210) may continue to play a video 2214a following the video 2204a prior to capture through the area 2214.

In an embodiment, the electronic device 200 (e.g., the processor 210) may display the second screen 2212 together with a second editing interface 2216, based on the screen capture command having been performed. The second editing interface 2216 may include at least one of a scroll capture interface, an area selection interface, tag insertion, or a sharing interface. The second editing interface 2216 may be displayed at least partially overlapping the second screen 2212 or displayed outside of the second screen 2212.

In an embodiment, the electronic device 200 (e.g., the processor 210) may display a first thumbnail image 2212a of the second screen 2212 including an image frame (e.g., a best image frame 2224a) selected among the plurality of image frames in the form of a preview for a predetermined time period, and then remove the first thumbnail image 2212a from the display module 230. In an embodiment, the electronic device 200 (e.g., the processor 210) may display a second thumbnail image 2215a of the second screen 2212 within the second editing interface 2216 after the first thumbnail image 2212a is removed. In an embodiment, when capture of the plurality of image frames according to the screen capture command is completed, the electronic device 200 (e.g., the processor 210) may replace the high-speed capture animation interface 2208a with the second thumbnail image 2216a.

In an embodiment, the second editing interface 2216 may further include a multi-thumbnail interface 2216b for editing the plurality of captured image frames and the second screen. In an embodiment, the multi-thumbnail interface 2216b may include an image of a plurality of partially overlapping thumbnails to indicate that a plurality of image frames have been captured. The electronic device 200 (e.g., the processor 210) may proceed to FIG. 22C, based on receiving a user input (e.g., a touch) for the multi-thumbnail interface 2216b.

Referring to FIG. 22C, the electronic device 200 (e.g., the processor 210) may display a third screen 2222, based on a user input (e.g., a touch) for the multi-thumbnail interface 2216b in the second editing interface 2216. In an embodiment, the third screen 2222 may include one image frame 2224a (e.g., a best image frame) selected from among the plurality of image frames captured based on the screen capture command, in an area 2224 corresponding to the area 2204 including the video 2204a being played. In an embodiment, the plurality of image frames may include 8 image frames, and 1st, 2nd, 4th, 5th, and 7th image frames may include shaken images, and 3rd, 6th, and 8th image frames may include images having different focuses. The electronic device 200 (e.g., the processor 210) may select the third image frame, for example, among the plurality of image frames to be displayed as a representative.

In an embodiment, the third screen 2222 may display a third editing interface 2228 and a thumbnail list interface 2226 together with the image of the second screen 2212. In an embodiment, at least one of the thumbnail list interface 2226 and the third editing interface 2228 may be displayed to at least partially overlap the third screen 2222. In an embodiment, the third editing interface 2228 may include at least one of a pen input interface, a sharing interface, or a storage interface.

In an embodiment, the thumbnail list interface 2226 may include a plurality of image symbols respectively corresponding to a plurality of image frames captured from the video 2204a being played. The image symbols may include a number indicating an order in which the plurality of image frames have been captured and/or a thumbnail image of the plurality of image frames. In an embodiment, the electronic device 200 (e.g., the processor 210) may display the plurality of image symbols in the thumbnail list interface 2226 by arranging the plurality of image symbols in a horizontal and/or vertical direction, by arranging the plurality of image symbols in a grid form, or by displaying the plurality of image symbols one by one while displaying the plurality of image symbols in a slide manner according to a user input.

In an embodiment, the electronic device 200 (e.g., the processor 210) may display the selected image frame 2224a (e.g., the 3rd image frame) in the area 2224 and may also display a number (e.g., “3”) indicating the captured order of the selected image frame 2224a in the area 2224 (or at least partially overlapping the area 2224). In an embodiment, the electronic device 200 (e.g., the processor 210) may emphasize and display an image symbol (e.g., the first image symbol 2226a) corresponding to the selected image frame 2224a displayed in the area 2224 among the plurality of image symbols included in the thumbnail list interface 2226. For example, the first image symbol 2226a may include a circle including the number 3, and may be emphasized with a different color, a larger size, or a bold outline than other image symbols.

In an embodiment, the electronic device 200 (e.g., the processor 210) may proceed to FIG. 22D to display an image frame corresponding to the user input (e.g., a touch) received on any one of the plurality of image symbols in the thumbnail list interface 2226, based on receiving the user input.

Referring to FIG. 22D, the electronic device 200 (e.g., the processor 210) may, based on receiving a user input (e.g., a touch) for selecting the 6th image symbol 2226b among the plurality of image symbols in the thumbnail list interface 2226, display the 6th image frame 2224b in the area 2224. Based on the user input, the third screen 2222 may be displayed to include the 6th image frame 2224b instead of the 3rd image frame 2224a in the area 2224. The electronic device 200 (e.g., the processor 210) may visually emphasize and display the 6th image symbol 2226b, based on the user input.

In an embodiment, based on receiving the user input (e.g., a touch) for the store interface 2228a of the third editing interface 2228 while displaying the third screen 2222 including the 6th image frame in the area 2224, the electronic device 200 (e.g., the processor 210) may store the third screen 2222 including the 6th image frame in the area 2224 as an image file.

An electronic device 200 according to an embodiment of the disclosure may include memory 240 storing instructions, a display module 230, and at least one processor 210 operatively connected to the memory and the display module. The instructions may, when executed by the at least one processor, cause the electronic device to receive a screen capture command. The instructions may, when executed by the at least one processor, cause the electronic device to, based on the screen capture command, determine whether an area including at least one moving object exists in a screen being displayed through the display module. The instructions may, when executed by the at least one processor, cause the electronic device to obtain a plurality of image frames captured at a plurality of different time points from the screen in case that there is an area including the at least one moving object existing within the screen. The instructions may, when executed by the at least one processor, cause the electronic device to store at least one image file including at least one selected image frame among the plurality of image frames.

In an embodiment, the instructions may cause the electronic device to obtain a single image frame captured from the screen, in case that there is no area including the at least one moving object within the screen, and to store an image file including the obtained image frame.

In an embodiment, the instructions may cause the electronic device to display, through the display module, a plurality of thumbnail images corresponding to the plurality of image frames, select, based on the plurality of thumbnail images, at least one first image frame from among the plurality of image frames, display, through the display module, recommendation information related to the selected at least one first image frame, and store at least one image file including the selected at least one first image frame.

In an embodiment, the instructions may cause the electronic device to display, through the display module, a first effect interface for highlighting the entire screen and a second effect interface for highlighting the area, based on the screen capture command, display, through the display module, a high-speed capture animation interface including a count of at least one image frame captured from the area, while obtaining the plurality of image frames, based on the screen capture command, display, through the display module, a thumbnail list interface including image symbols respectively corresponding to the plurality of image frames, after the plurality of image frames are obtained, display, through the display module, a screen including a first image frame corresponding to a first image symbol, based on a user input for selecting the first image symbol in the thumbnail list interface, and store at least one image file including at least one first image frame.

In an embodiment, the instructions may cause the electronic device to display, through the display module, an editing interface associated with the area in the second image frame selected from the plurality of image frames, edit the second image frame by using the editing interface, and store a second image file including the edited second image frame.

In an embodiment, the instructions may cause the electronic device to display the editing interface to be visually associated with a thumbnail image of the second image frame.

In an embodiment, the editing interface may include at least one of a playback interface for playing a video in a designated area of the second image frame, a scene selection interface for selecting a still image to be included in the designated area of the second image frame, an area editing interface for editing the designated area of the second image frame, or an object editing interface for editing at least one object included in the second image frame.

In an embodiment, the instructions may cause the electronic device to receive a first user input through the area editing interface, display, through the display module, at least one of a first input interface for hiding the area or a second input interface for cropping the area, based on the first user input, display, through the display module, the second image frame in which the still image in the area is replaced with designated information, based on a second user input received through the first input interface, and display, through the display module, the second image frame in which the area is deleted, based on a third user input received through the second input interface.

In an embodiment, the instructions may cause the electronic device to receive a first user input through the object editing interface, and based on the first user input, display at least one of a first input interface for object deletion or a second input interface for object change through the display module, receive a second user input through the first input interface, receive a third user input for selecting at least one first object included in the second image frame after the second user input is received, display, through the display module, the second image frame in which the first object is deleted, based on the third user input, receive a fourth user input through the second input interface, receive a fifth user input for selecting at least one second object included in the second image frame, based on the fourth user input, and display, through the display module, the second image frame in which the at least one second object is replaced with at least one third object included in a third image frame among the plurality of image frames, based on the fifth user input.

In an embodiment, the instructions may cause the electronic device to capture the plurality of image frames corresponding to a plurality of time points including the time point at which the screen capture command is received.

According to an embodiment of the disclosure, provided may be a non-transitory computer-readable storage medium storing one or more programs, wherein the one or more programs may include instructions, when executed by at least one processor of an electronic device, causing the electronic device to receive a screen capture command, determine whether there is an area including at least one moving object in a screen displayed through a display module, based on the screen capture command, obtain a plurality of image frames captured from the screen at a plurality of different time points, in case that there is an area including the at least one moving object existing within the screen, and store at least one image file including at least one selected image frame among the plurality of image frames.

In an embodiment, the one or more programs may include instructions causing the electronic device to obtain a single image frame captured from the screen, in case that there is no area including the at least one moving object within the screen, and to store an image file including the obtained image frame.

In an embodiment, the one or more programs may include instructions causing the electronic device to display, through the display module, a plurality of thumbnail images corresponding to the plurality of image frames, select, based on the plurality of thumbnail images, at least one first image frame from among the plurality of image frames, display, through the display module, recommendation information related to the selected at least one first image frame, and store at least one image file including the selected at least one first image frame.

In an embodiment, the one or more programs may include instructions causing the electronic device to display, through the display module, a first effect interface for highlighting the entire screen and a second effect interface for highlighting the area, based on the screen capture command, display, through the display module, a high-speed capture animation interface including a count of at least one image frame captured from the area, while obtaining the plurality of image frames, based on the screen capture command, display, through the display module, a thumbnail list interface including image symbols respectively corresponding to the plurality of image frames, after the plurality of image frames are obtained, display, through the display module, a screen including a first image frame corresponding to a first image symbol, based on a user input for selecting the first image symbol in the thumbnail list interface, and store at least one image file including at least one first image frame.

In an embodiment, the one or more programs may include instructions causing the electronic device to display, through the display module, an editing interface associated with the area of the second image frame selected from the plurality of image frames, edit the second image frame by using the editing interface, and store a second image file including the edited second image frame.

In an embodiment, the one or more programs may include instructions causing the electronic device to display the editing interface to be visually associated with a thumbnail image of the second image frame.

In an embodiment, the editing interface may include at least one of a playback interface for playing a video in a designated area of the second image frame, a scene selection interface for selecting a still image to be included in the designated area of the second image frame, an area editing interface for editing the designated area of the second image frame, or an object editing interface for editing at least one object included in the second image frame.

In an embodiment, the one or more programs may include instructions causing the electronic device to receive a first user input through the area editing interface, display, through the display module, at least one of a first input interface for hiding the area or a second input interface for cropping the area, based on the first user input, display, through the display module, the second image frame in which the still image in the area is replaced with designated information, based on a second user input received through the first input interface, and display, through the display module, the second image frame in which the area is deleted, based on a third user input received through the second input interface.

In an embodiment, the one or more programs may include instructions causing the electronic device to receive a first user input through the object editing interface, and based on the first user input, display at least one of a first input interface for object deletion or a second input interface for object change through the display module, receive a second user input through the first input interface, receive a third user input for selecting at least one first object included in the first image frame after the second user input is received, display, through the display module, the second image frame in which the first object is deleted, based on the third user input, receive a fourth user input through the second input interface, receive a fifth user input for selecting at least one second object included in the second image frame, based on the fourth user input, and display, through the display module, the second image frame in which the at least one second object is replaced with at least one third object included in a third image frame among the plurality of image frames, based on the fifth user input.

In an embodiment, the one or more programs may include instructions causing the electronic device to capture the plurality of image frames corresponding to a plurality of time points including the time point at which the screen capture command is received.

A method performed by an electronic device according to an embodiment of the disclosure may include receiving a screen capture command, based on the screen capture command, determining whether an area including at least one moving object exists in a screen being displayed through a display module, in case that the area including the at least one moving object exists on the screen, obtaining a plurality of image frames captured at a plurality of different time points from the screen, and storing at least one image file comprising at least one image frame selected from among the plurality of image frames.

In an embodiment, the method may further comprise, in case that the area including the at least one moving object does not exist in the screen, obtaining one image frame captured from the screen, and storing an image file comprising the obtained image frame.

In an embodiment, the method may further comprise, displaying, through the display module, a plurality of thumbnail images corresponding to the plurality of image frames, based on the plurality of thumbnail images, selecting at least one first image frame from among the plurality of image frames, displaying, through the display module, recommendation information related to the selected at least one first image frame, and storing at least one image file comprising the selected at least one first image frame.

In an embodiment, the method may further comprise, based on the screen capture command, displaying, through the display module, a first effect interface highlighting the entire screen and a second effect interface highlighting the area, while obtaining the plurality of image frames, based on the screen capture command, displaying, through the display module, a high-speed capture animation interface comprising a count of at least one image frame captured from the area, after the plurality of image frames are obtained, displaying, through the display module, a thumbnail list interface comprising image symbols corresponding to the plurality of image frames respectively, based on a user input for selecting a first image symbol from among the thumbnail list interface, displaying, through the display module, a screen comprising a first image frame corresponding to the first image symbol, and storing an image file comprising the first image frame.

In an embodiment, the method may further comprise, displaying, through the display module, an editing interface related to the area in a second image frame selected from among the plurality of image frames, editing the second image frame by using the editing interface, storing a second image file comprising the edited second image frame, and displaying the editing interface in visual association with a thumbnail image of the second image frame,

In an embodiment, the editing interface comprises at least one of: a playback interface for playing a video in a specified area within the second image frame, a scene selection interface for selecting a still image to be included in the specified area in the second image frame, an area editing interface for editing the specified area in the second image frame, or an object editing interface for editing at least one object included in the second image frame.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 210) of the machine (e.g., the electronic device 101, for example, master device or task performing device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing instructions;
a display module; and
at least one processor operatively connected with the memory and the display module,
wherein the instructions, when executed by the at least one processor individually or collectively, cause the electronic device to:
receive a screen capture command,
based on the screen capture command, determine whether an area including at least one moving object exists in a screen being displayed through the display module,
based on the area including the at least one moving object existing on the screen, obtain a plurality of image frames captured at a plurality of different time points from the screen, and
store at least one image file including at least one image frame selected from among the plurality of image frames.

2. The electronic device of claim 1, wherein the instructions, when executed by the at least one processor individually or collectively, further cause the electronic device to:
based on the area including at least one moving object not existing in the screen, obtain one image frame captured from the screen, and
store an image file including the obtained image frame.

3. The electronic device of claim 1, wherein the instructions, when executed by the at least one processor individually or collectively, further cause the electronic device to:
display, through the display module, a plurality of thumbnail images corresponding to the plurality of image frames,
based on the plurality of thumbnail images, select at least one first image frame from among the plurality of image frames,
display, through the display module, recommendation information related to the selected at least one first image frame, and
store at least one image file including the selected at least one first image frame.

4. The electronic device of claim 1, wherein the instructions, when executed by the at least one processor individually or collectively, further cause the electronic device to:
based on the screen capture command, display, through the display module, a first effect interface highlighting an entire of the screen and a second effect interface highlighting the area,
while acquiring the plurality of image frames based on the screen capture command, display, through the display module, a high-speed capture animation interface including a count of at least one image frame captured from the area,
after the plurality of image frames are obtained, display, through the display module, a thumbnail list interface including image symbols respectively corresponding to the plurality of image frames,
based on a user input for selecting a first image symbol among the thumbnail list interface, display, through the display module, a screen including a first image frame corresponding to the first image symbol, and
store an image file including the first image frame.

5. The electronic device of claim 1, wherein the instructions, when executed by the at least one processor individually or collectively, further cause the electronic device to:
display, through the display module, an editing interface related to the area in a second image frame selected from among the plurality of image frames,
edit the second image frame using the editing interface, and
store a second image file including the edited second image frame.

6. The electronic device of claim 5, wherein the instructions, when executed by the at least one processor individually or collectively, further cause the electronic device to:
display the editing interface in visual association with a thumbnail image of the second image frame.

7. The electronic device of claim 5, wherein the editing interface comprises at least one of:
a playback interface for playing a video in a specified area within the second image frame,
a scene selection interface for selecting a still image to be included in the specified area in the second image frame,
an area editing interface for editing the specified area in the second image frame; or
an object editing interface for editing at least one object included in the second image frame.

8. The electronic device of claim 7, wherein the instructions, when executed by the at least one processor individually or collectively, further cause the electronic device to:
receive a first user input via the area editing interface,
based on the first user input, display, through the display module, at least one of a first input interface for hiding the area, or a second input interface for cropping out the area,
based on a second user input received via the first input interface, display, through the display module, the second image frame in which a still image in the area is replaced with specified information, and
based on a third user input received via the second input interface, display, through the display module, the second image frame in which the area is deleted.

9. The electronic device of claim 7, wherein the instructions, when executed by the at least one processor individually or collectively, further cause the electronic device to:
receive a first user input through the object editing interface,
based on the first user input, display, through the display module, at least one of a first input interface for deleting an object or a second input interface for changing an object,
receive a second user input via the first input interface,
after receiving the second user input, receive a third user input for selecting at least one first object included in the second image frame,
based on the third user input, display, through the display module, the second image frame in which the at least one first object is deleted,
receive a fourth user input via the second input interface,
based on the fourth user input, receive a fifth user input for selecting at least one second object included in the second image frame, and
based on the fifth user input, display, through the display module, the second image frame in which the at least one second object is replaced with at least one third object included in a third image frame among the plurality of image frames.

10. The electronic device of claim 1, wherein the instructions, when executed by the at least one processor individually or collectively, further cause the electronic device to:
capture the plurality of image frames corresponding to a plurality of time points including a time point at which the screen capture command is received.

11. One or more non-transitory computer-readable storage media storing one or more computer programs including computer-executable instructions that, when executed by one or more processors of an electronic device individually or collectively, cause the electronic device to perform operations, the operations comprising:
receiving a screen capture command;
based on the screen capture command, determining whether an area including at least one moving object exists in a screen being displayed through a display module;
in case that the area including the at least one moving object exists on the screen, obtaining a plurality of image frames captured at a plurality of different time points from the screen; and
storing at least one image file comprising at least one image frame selected from among the plurality of image frames.

12. The one or more non-transitory computer-readable storage media of claim 11, the operations further comprising:
in case that the area including the at least one moving object does not exist in the screen, obtaining one image frame captured from the screen; and
storing an image file comprising the obtained image frame.

13. The one or more non-transitory computer-readable storage media of claim 11, the operations further comprising:
displaying, through the display module, a plurality of thumbnail images corresponding to the plurality of image frames;
based on the plurality of thumbnail images, selecting at least one first image frame from among the plurality of image frames;
displaying, through the display module, recommendation information related to the selected at least one first image frame; and
storing at least one image file comprising the selected at least one first image frame.

14. The one or more non-transitory computer-readable storage media of claim 11, the operations further comprising:
based on the screen capture command, displaying, through the display module, a first effect interface highlighting the entire screen and a second effect interface highlighting the area;
while obtaining the plurality of image frames, based on the screen capture command, displaying, through the display module, a high-speed capture animation interface comprising a count of at least one image frame captured from the area;
after the plurality of image frames are obtained, displaying, through the display module, a thumbnail list interface comprising image symbols corresponding to the plurality of image frames respectively;
based on a user input for selecting a first image symbol from among the thumbnail list interface, displaying, through the display module, a screen comprising a first image frame corresponding to the first image symbol; and
storing an image file comprising the first image frame.

15. The one or more non-transitory computer-readable storage media of claim 11, the operations further comprising:
displaying, through the display module, an editing interface related to the area in a second image frame selected from among the plurality of image frames;
editing the second image frame by using the editing interface;
storing a second image file comprising the edited second image frame; and
displaying the editing interface in visual association with a thumbnail image of the second image frame,
wherein the editing interface comprises at least one of:
a playback interface for playing a video in a specified area within the second image frame,
a scene selection interface for selecting a still image to be included in the specified area in the second image frame,
an area editing interface for editing the specified area in the second image frame, or
an object editing interface for editing at least one object included in the second image frame.

16. A method performed by an electronic device, the method comprising:
receiving a screen capture command;
based on the screen capture command, determining whether an area including at least one moving object exists in a screen being displayed through a display module;
in case that the area including the at least one moving object exists on the screen, obtaining a plurality of image frames captured at a plurality of different time points from the screen; and
storing at least one image file comprising at least one image frame selected from among the plurality of image frames.

17. The method of claim 16, further comprising:
in case that the area including the at least one moving object does not exist in the screen, obtaining one image frame captured from the screen; and
storing an image file comprising the obtained image frame.

18. The method of claim 17, further comprising:
displaying, through the display module, a plurality of thumbnail images corresponding to the plurality of image frames;
based on the plurality of thumbnail images, selecting at least one first image frame from among the plurality of image frames;
displaying, through the display module, recommendation information related to the selected at least one first image frame; and
storing at least one image file comprising the selected at least one first image frame.

19. The method of claim 18, further comprising:
based on the screen capture command, displaying, through the display module, a first effect interface highlighting the entire screen and a second effect interface highlighting the area;
while obtaining the plurality of image frames, based on the screen capture command, displaying, through the display module, a high-speed capture animation interface comprising a count of at least one image frame captured from the area;
after the plurality of image frames are obtained, displaying, through the display module, a thumbnail list interface comprising image symbols corresponding to the plurality of image frames respectively;
based on a user input for selecting a first image symbol from among the thumbnail list interface, displaying, through the display module, a screen comprising a first image frame corresponding to the first image symbol; and
storing an image file comprising the first image frame.

20. The method of claim 19, further comprising:
displaying, through the display module, an editing interface related to the area in a second image frame selected from among the plurality of image frames;
editing the second image frame by using the editing interface;
storing a second image file comprising the edited second image frame; and
displaying the editing interface in visual association with a thumbnail image of the second image frame,
wherein the editing interface comprises at least one of:
a playback interface for playing a video in a specified area within the second image frame,
a scene selection interface for selecting a still image to be included in the specified area in the second image frame,
an area editing interface for editing the specified area in the second image frame, or
an object editing interface for editing at least one object included in the second image frame.
